(19) United States
(12) Patent Application Publication
(10) Pub. No.: US 2019/0352022 A1
(43) Pub. Date: Nov. 21, 2019

(54) Force Cell to Provide Propellant-Less Propulsion for Linear Thrust Applications and Fuel-Less Torque for Rotary Applications Using External Casimir Forces

(71) Applicant: Robert L. De Biase, Staten Island, NY (US)

(72) Inventor: Robert L. De Biase, Staten Island, NY (US)

(21) Appl. No.: 16/295,098

(22) Filed: Mar. 7, 2019

Related U.S. Application Data
(60) Provisional application No. 62/672,171, filed on May 16, 2018.

(51) Int. Cl. B64G 1/40

(52) U.S. Cl. CPC B64G 1/405

(57) ABSTRACT

The force cell provides propellant-less propulsion for linear thrust applications and fuel-less torque for rotory applications. Linear thrust applications include propulsion for aircraft, spacecraft, flying cars, construction equipment for use in low and zero gravity environments, stabilization for ultra high buildings and realization of ultra long unsupported spans. Rotary torque applications include engines to drive electric generators of all sizes—from mobile phone size to power station size. Force cells use radiation pressure originating from the zero-point fields in the vacuum of space—the force in the Casimir effect, to produce a macroscopic external force through use of a multiplicity of microscopic Casimir cavities consisting of wedge shaped non-charged conducting plates attached to a matrix of non-conducting material. Force cells arranged in balanced pairs can produce modulated external thrust. Force cells arranged circularly can produce modulated torque.

### CROSS REFERENCES TO RELATED APPLICATIONS

This application claims priority on U.S. Provisional Application Ser. No. 62/672,171, filed on May 16, 2018, the disclosures of which are incorporated herein by reference.

### FIELD OF THE INVENTION

The present invention relates to apparatus for providing propellant-less propulsion for linear thrust applications and fuel-less torque for rotary applications, and more particularly to apparatus that includes a plurality of particularly shaped and coated nano-scale wedges that are conceived and constructed to provide improved thrust and torque using Casimir forces.

### BACKGROUND OF THE INVENTION

The present invention includes particularly configured apparatus that provides improved propellantless propulsion using one or more three cells that can he used to achieve practical propulsion for aircraft, spacecraft with hovering capability and other applications requiring propulsion. The current invention depends upon the Casimir effect whereby the Casimir force, or at least a sizable portion of it, arises from energy fluctuations in the vacuum of space itself. These fluctuations, which occur in both matter and free space, result from the Heisenberg uncertainty principle of quantum mechanics. Because these fluctuations persist even when all thermal black body radiation has been eliminated at absolute zero temperature, they are often called zero-point fields.

In 1948 Dr. Hendrick B. G. Casimir along with Dr. Dirk Polder wrote a seminal paper, entitled: “The Influence of Retardation on the London-ran der Wools Forces”, Van der Waals forces occur between atoms and molecules at distances typically less than 1 nm and are responsible for the cohesion of most solid materials. If the forces result from two instantaneous induced dipoles, they are called London-van der Walls forces and if the bulk matter making up the plates are composed of dielectric material and separated by distances of from about 100 nm to about a micron (1 μm), the effects of retardation must be included and this extension of the van der Waals forces is also called a Casimir-Polder force. This interpretation explicitly depends upon the zero-point fluctuations of the polarizable atoms in the bulk matter making up the plates. Casimir-Polder forces can be attractive or repulsive depending upon the electrical and magnetic properties of the materials being used.

Also in 1948 Casimir authored a second paper entitled: “On the attraction between two perfectly conducting plates”. This paper is premised upon the difference in the sum of the resonant frequencies of all virtual photons within a cavil y consisting of two perfectly conducting uncharged parallel plates and the sum of the virtual photon frequencies outside the cavity. Where these virtual photons originate from is not explicitly stated. They could result from molecular potentials of matter nearby, but they could also originate from the zero-point fluctuations of fields within a perfect vacuum.

The first attempt to measure the Casimir force was by M. Sparnaay in 1958. His results were inconclusive but consistent with Casimir's prediction. The first direct measurement was by S. K. Lamoreaux in 1997 between a large sphere-shaped lens and flat plate using a torsion pendulum. The first atomic force microscope (AFM) experiment was to 1998 by U. Mohideen and A. Roy measuring the threes between a 200 μm gold coated sphere and a gold coated flat plate. The first measurement of lateral Casimir forces between a corrugated sphere and corrugated flat plate was by F. Chen, U. Mohideen, G. L. Klimchitskaya and V. M. Mostepanenko in 2002 using an AFM. In 2004 a NASA study performed much more precise measurements using a variety of geometric cavity shapes and materials (see, Final Report: Study of Vacuum Energy Physics for Breakthrough Propulsion, G. Jordan Maclay et ah. October 2004, NASA/CR—2004-213311).

When the zero-point fluctuations originate from the vacuum of space they a external to the Casimir plates, potentially allowing energy to be extracted. Methods of calculating force that are consistent with this interpretation include on based upon radiation pressure. For perfectly conducting parallel plates, the plate boundaries essentially ground the electric field of the impinging photon thus resulting in a zero node at the boundary and thus allowing only an integral number of half wavelengths between the plates. The resulting suppression of vibrating modes within the cavity means that there is less energy between the plates than external to them resulting in a pressure pushing the plates together. Non-parallel plates can be calculated by breaking the non-parallel plates up into a set of adjoining parallel plates. The resulting approximation known as the Proximity Force Approximation (PFA) or the Derjaguin approximation is valid for plates where the plate curvature is not too great and is still being used to gauge experiments.

An “exact” solution for a perfectly conducting wedge (PCW) is found in a paper by V. V. Nesterenko, G. Lambiase and G. Scarpetta of 2002. It is exact in the sense that the energy and forces calculated use solutions specifically for a wedge as opposed to the PFA, which is based upon the solution for perfectly conducting parallel plates. Moreover the perfectly conducting wedge predicts equal and opposite torques on the plate faces, which can be decomposed into two equal and opposite forces that cancel out and two forces in the direction of the wedge cross-section angle bisector that add up producing an external force as shown in FIG. 1.

The results of the Nesterenko, Lambiase, Scarpetta paper are in agreement with the results published in a paper by I. Brevik and M. Lygren in 1996, who used Schwinger source theory for their calculation of the Casimir effect for a perfectly conducting wedge. The Brevik and Lygren paper is in turn in agreement with the results published in a paper by Deutsch and Candelas in 1979 as well as Helliwell and Konkowski in 1986 for the same wedge geometry using different approaches.

There are a number of patents and patent application publications that relate to the Casimir Effect, including: U.S. Pat. No. 5,590,031 to Mead; U.S. Pat. No. 6,477,028; U.S. Pat. No. 6,593,566 to Pinto; U.S. Pat. No. 6,650,727 to Pinto; U.S. Pat. No. 6,665,167 to Pinto: U.S. Pat. No. 6,842,326 to Pinto; U.S. Pat. No. 6,920,032 to Pinto; U.S. Pat. No. 7,379,286 to Haisch; U.S. Pat. No. 7,411,772 to Tymes; U.S. Patent App. Pub. No. 2011/0073715 by Macaulife; U.S. Pat. No. 8,039,368 to Dryndie; U.S. Pat. No. 8,174,706 to Pinto; U.S. Pat. No. 8,317,137 to Cormier;

Non-patent literature relating to propulsion and/or the Casmir Effect includes the following.
Casimir H. B. G. and Polder D., “The Influence of Retardation on the London-van der Waals Forces,” Physical Review 1948; 73(4).
Casimir H. B. G. “On the attraction between two perfectly conducting plates,” Proc. K. Ned. Akad. Wet. 1948; 51: 793-795.
Maclay G. J., Forward R. I. “A gedanken spacecraft that operates using the quantum vacuum (dynamic Casimir effect),” Foundations of Physics 2004; 34(3): 477-500.
Lambrecht A., “The Casimir effect: a force from nothing,” Physics World, September 2002.
Maclay G. J., “The role of quantum vacuum forces microelectromechanical systems,” In: Krasnoholovets V., editor, Progress in Quantum Physics Research, New York, N. Y. Nova Science; 2003.
Kenneth O., Klich I., Mann A., Revzen M., “Repulsive Casimir Forces,” Physical Review Letters 2002; 89(3), 033001
Tajmar M, “Finite Element Simulation of Casimir Forces in Arbitrary Geometries,” Int. J. Mod. Phys. C 2004; 15: 1387-1395
Dalvit DAR, Neto PAM, Lambrecht A, Reynaud S, “Lateral Casimir-Polder force with corrugated surfaces,” J. Phys. A: Math. Theor. 2008; 41: 164028 (11 pp).
Ederth T., “Template-stripped gold surfaces with 0.4-nm roughness suitable for force measurements: Application to the casimir force in the 20-100-nm range,” Physical Review A 2000; 62: 062104-1.
Milonni P. W., Cook R. J. Goggin M E. “Radiation pressure from the vacuum: Physical interpretation of the Casimir force,” Phys Rev A. 1988; 38: 1621-3.
Chen E., Mohideen U., Klimehitskaya Mostepanenko V. M. “Demonstration of the lateral Casimir force,” PhysRevLett 2002; 88(10): 101801.
Lambrecht A., Neto P. A. M., Reynaud S. “The Casimir effect within scattering theory,” New Journal of Physics 2006; 8: 243.
Milton K. A., Wagner J. “Multiple scattering methods in Casimir calculations,” J. Phys. A: Math. Theor. 2008; 41: 155402.
Chiu H. C., Klimchitskaya G. L., Marachevsky V. N., Mostepanenko V. M., Mohideen U. “Demonstration of the asymmetric lateral Casimir force between corrugated surfaces in the nonadditive regime,” Phys. Rev. B 2009; 80, Issue 12. id. 121402.
Millis M. G., “Assessing Potential Propulsion Breakthroughs”, Ann. N.Y. Acad. Sci. 2005; 1065: 441-461.
Cole D. C., Puthoff H. E., “Extracting energy and heat from the vacuum,” Phys Rev E 1993; 48: 1562-1565.
Nesterenko V. V., Lambiase G., Scarpetta G. “Casimir effect for a perfectly conducting wedge in terms of local zeta function,” Elsevier Annals of Physics 2002; 293, Issue 2: 403-420.
Brevik I., Lygren M., “Casimir effect for a perfectly conducting wedge,” Annals of Physics 1996; 251, Number 2: 157-179.
Brevik I., Pettersen K., “Casimir Effect for a Dielectric Wedge,” Annals of Physics 2001; 291, Issue 2: 267-275.
Brevik I., Ellingsen S., Milton K., “Electromagnetic Casimir Effect in Wedge Geometry and the Energy-Momentum Tensor in Media,” Int. J. Mod. Phys. A 2010; 25, Issue 11: 2270-2278.
Deutsch D., Candelas P., “Boundary effects in quantum field theory,” Phys. Rev. D 1979; 20: 3063-3080.
Razmi H., Modarresi S. M. “Casimir Torque for a Perfectly Conducting Wedge: A Canonical Quantum Field Theoretical Approach,” International Journal of Theoretical Physics 2005; 44, Issue 2: 229-234.
Helliwell T. M., Konkowski D. A., “Vacuum fluctuations outside cosmic strings,” Phys, Rev. D 1986; 34: 1918.
Balian R., Duplantier B., “Electromagnetic waves near perfect conductors. I. Multiple scattering expansions. Distribution of modes,” Annals of Physics 1977; 104, issue 2: 300-335.
   Balian R., Duplantier B., “Electromagnetic waves near perfect conductors. II. Casimir effect.,” Annals of Physics 1978; 112, Issue 1: 165-708.
Mohideen U., Roy A., “Precision Measurement of the Casimir Force from 0.1 to 0.9 μm,” PhysRevLett 1998: 81(21): 4549.
DeBiase R. L., “A Light Sail Inspired to Harness Casimir Forces for Propellantless Propulsion”, Space Propulsion & Energy Sciences International Forum—2010.
DeBiase R. L. “Are Casimir forces conservative,” Space, Propulsion & Energy Sciences international Forum—2012.
DeBiase R. L., “The equivalence of the vacuum and bulk matter interpretations of the Casimir effect,” ResearchGate.net—2017.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The following calculations are for wedge geometries that will be useful in the further discussion of the invention.

### Force Calculations for the Perfectly Conducting Wedge

The various perfectly conducting wedge papers calculate a Casimir force per unit area of the wedge plates from which a torque and total force perpendicular to each plate, F_{⊥1} and F_{⊥2}, can be determined. These tend to diminish the angle between the wedge plates for the wedge shown in FIG. 1.

These papers do not comment on whether such a wedge configuration could generate external forces since that was not their intent. Their intent was to characterize cosmic strings by employing the mathematics for Casimir wedges since the two phenomena are parallel. However it is obvious that F_{⊥1} and F_{⊥2} in the wedges can be decomposed into two forces in the x direction that are equal and opposite and thus cancel out, and two forces in the z direction, F_{⊥1} and F_{⊥2} that add up.

The papers provide an equation expressing the force per unit wedge face area in terms of the wedge angle β and distance from wedge vertex r, obtained from the energy-momentum tensor:

$$f ( r ) = \frac{hc ( {p}^{2} - 1 ) ( {p}^{2} + 11 )}{240 {π}^{2} {r}^{4}} , where p = \frac{π}{β} \qquad ( 1 )$$

See e.g. Eq. 3.43 in Nesterenko V. V., Lambiase G., Scarpetta G. of 2002 or Eq. 2 and Eq. 53 of Brevik I., Lygren M. of 1996. These papers use Heaviside-Lorentz units, which set universal constants equal to unity. For making calculations. SI units are more convenient. Subsequently h is Planck's constant=6.626*10⁻²⁷ erg*sec, η[pronounced h bar] is the reduced Planck's constant which equals h/2π and c is the speed of light=2.998*10¹⁰ cm/sec.

The magnitude of total force perpendicular to a wedge surface is then:

$${F}_{⊥ 1} ( β , {R}_{0} , {R}_{1} ) = {F}_{⊥ 2} ( β , {R}_{0} , {R}_{1} ) = {\int }_{0}^{Y} dy {\int }_{{R}_{0}}^{{R}_{1}} f ( r ) dr = \vert \frac{hcY ( {p}^{2} - 1 ) ( {p}^{2} + 11 )}{720 {π}^{2}} ( \frac{1}{{R}_{1}^{3}} - \frac{1}{{R}_{0}^{3}} ) \vert \qquad ( 2 )$$

The forces in the z direction for each plate as depicted in FIG. 1 will then be:

$${F}_{z 1} ( β , {R}_{0} , {R}_{1} ) = {F}_{z 2} ( β , {R}_{0} , {R}_{1} ) = sin ( \frac{β}{2} ) \vert \frac{hcY ( {p}^{2} - 1 ) ( {p}^{2} + 11 )}{720 {π}^{2}} ( \frac{1}{{R}_{1}^{3}} - \frac{1}{{R}_{0}^{3}} ) \vert \qquad ( 3 )$$

The distance R₀, which is the distance from the vertex of the wedge to the start of the active part of the wedge cannot be zero, otherwise the force would blow up. Physically this situation is not a problem since the wedge conductor needs to be at least 10 nm thick for the photon to even “see” the conductor. This distance is further wavelength limited by the plasma wavelength (λ_{ρ}). Photons with wavelengths less than the plasma wavelength tend to go through the conductor without interacting. Though in reality the plasma wavelength is not a specific boundary, an effective plasma wavelength can be used to simplify calculations and will be used throughout this disclosure.

Plasma wavelength is material dependent. However, in the literature there are significant differences between calculated and measured plasma wavelengths and different groups measure different values. The value used in this disclosure, 130 nm, is close to that of gold used in the Chen/Mohideen experiment of 2002 and is probably conservative since subsequent sample calculations assume aluminum for the conductor for which plasma wavelength range between 81 and 103 nm.

The total force F_{z}=F_{z1}+F_{z2} is plotted against angle β which varies from 0 to π and is shown in FIG. 3A. In this calculation

$${R}_{0} = \frac{{λ}_{p}}{2 sin ( \frac{β}{2} )} ,$$

R₁=1 μm and Y=1 cm where Y is an arbitrary width of the wedge going in the y direction.

PCW Calculations for Wedges Formed by the Intersection of Flat and Angular Plates

When a flat plate intersects an angular plate as shown in FIG. 2 there are two wedges that must be accounted for, one with angle α having perpendicular force F_{⊥}⁺ and the other with angle π-α having perpendicular force F_{⊥}⁻. The PCW calculation will be expressed in terms of the variables α, R₀, R₁ and R₂, where R₀ and R₁ depend upon plasma wavelength and R₂ is held constant while angle α varies. Noting from the geometry of FIG. 2 that

$$\begin{matrix}{R}_{0} = \frac{{λ}_{p}}{2 sin ( \frac{π - α}{2} )} , {R}_{1} = \frac{{λ}_{p}}{2 sin \frac{α}{2}} , p = \frac{π}{α} and \\ q = \frac{π}{π - α} one obtains \text{:} \\ {F}_{⊥}^{+} = \frac{ℏ cY ( {p}^{2} - 1 ) ( {p}^{2} + 11 )}{720 {π}^{2}} ( \frac{1}{{R}_{2}^{3}} - \frac{1}{{R}_{1}^{3}} ) and & ( 4 a ) \\ {F}_{⊥}^{-} = \frac{ℏ cY ( {q}^{2} - 1 ) ( {q}^{2} + 11 )}{720 {π}^{2}} ( \frac{1}{{R}_{2}^{3}} - \frac{1}{{R}_{0}^{3}} ) . & ( 4 b )\end{matrix}$$

Thus the magnitude of the Plate 2 PCW lateral (in the positive x direction) force for the FIG. 2 system will be;

F_{Lateral}=sin(α)·(|F_{⊥}⁺|−|F_{⊥}⁻|). (5)

Fₗₐₜₑᵣₐₗ is plotted against angle α which varies from 0 to π and is shown in FIG. 3B. In this calculation R₂−1 μm and Y−1 cm where Y is an arbitrary width of the wedge going in the y direction.

The Implicit in these calculations is the assumption that not only are the conductors being used perfectly conducting, but also the non-conductors are “perfectly” non-conducting. Real conductors have free electrons in the outer electron shell of their atoms, which allow for the flow of electrons. Real non-conductors or insulators have more tightly bound electrons, which don't allow electric current to flow. They are however to varying degree polarizable, which makes them dielectrics. In practice the strength of a dielectric can be gauged relative to the dielectric or permittivity constant of vacuum, which is ε₀=8.85×10⁻¹² farad/meter. Thus for an ordinary isotropic dielectric, the dielectric constant ε=εᵣ ε₀, where εᵣ is a dimensionless constant greater than 1. Correspondingly, there is a magnetic permeability constant η_{μ} μ₀, μ=μₜ μ₀, where η_{μ} μᵣ is also a dimensionless constant and μ₀=4π×10⁻⁷ henry/meter is the permeability constant of free space or vacuum.

$$f ( r ) = \frac{ℏ c ( {p}^{2} - 1 ) ( {p}^{2} + 11 )}{240 {π}^{2} \sqrt{{ɛ}_{r} {μ}_{r}} {r}^{4}} , where p = \frac{π}{β} \qquad ( 6 )$$

is a modified version of Eq.1 which accounts for the relative electric permittivity and magnetic permeability of the material within the cavity. When the cavity is vacuum, Eq. 6 becomes Eq. 1. This equation may be found as Eq. 38 in Brevik I., Pettersen K. of 2001.

The dielectric and permeability constants figure into the electrostatic and magnetic polarizability constants, α_{E1,2} and α_{M1,2} respectively, embedded in the Casimir-Polder equation shown as Eq. 7, which calculates the interaction energy potential between two atoms i and j in two different plates. Note that the electrostatic and magnetic polarizability constants α_{E} and α_{M} are not to he confused with wedge angle α.

$$u ( {r}_{ij} ) = - \frac{ℏ c}{4 π \cdot {r}_{ij}^{\text{?}}} [ 23 \cdot ( {α}_{E 1} {α}_{E 2} + {α}_{M 1} {α}_{M 2} ) - 7 \cdot ( {α}_{E 1} {α}_{M 2} + {α}_{M 1} {α}_{E 2} ) ] \\ \text{?} \text{indicates text missing or illegible when filed} \qquad ( 7 )$$

The Clausius-Mossotti (also known as the Lorentz-Lorenz) relationship provides a rule of thumb for how the electrostatic polarizability is related to the relative dielectric constant and gives an indirect relationship between relative dielectric and conductivity:

$${α}_{E} = \frac{3}{4 π N} \cdot \frac{{ɛ}_{r} - 1}{{ɛ}_{r} + 2} ,$$

where N is the number of atoms per unit volume. When the relative dielectric or permittivity is 1, the electrostatic polarizability becomes zero and when the material is a conductor and is generally attributed an infinite dielectric, the electrostatic polarizability reaches a maximum and the volume occupied by each atom also reaches a maximum so that the outside shells of atoms are nearly touching. Non-magnetic materials have a relative magnetic permeability of 1 and a magnetic polarizability of zero.

Adding up the energy of pairs of atoms in each plate and then taking the negative of the gradient calculates force. A characteristic of this process is that it predicts equal and opposite forces—no external forces. However pair-wise-summation is only valid when the plate material is in the additive regime which it will be when the plates have a low dielectric (note that at least for electronics, any dielectric material with a η εᵣ value less than the conventionally used SiO₂ (k εᵣ=3.9) is considered to be a low dielectric constant material). For conductors, some researchers scale up the PWS force values for non-parallel plates by the ratio of the pair-wise-summation calculation for parallel plates with the Casimir solution for perfectly conducting parallel plates [see Tajmar—2004]. But such assumes that the non-additivity only modifies the magnitude of the force values and not the directions. Given that the PWS parallel plates calculated forces are significantly less than the Casimir parallel plates calculated forces, both the Casimir-Polder approach predicting equal and opposite forces and the Casimir wedge theory, apparently predicting external forces, could both be true.

Laterally Oriented Wedges

The apparatus disclosed herein produces an external force from a multiplicity of particularly formed microscopic wedges. In a first embodiment, the wedges may be formed by creating a plurality of nano-scale V-shaped grooves on one side of a sheet of non-conducting matrix material, by coating a first conductor material onto a flat opposite side of the matrix material, and by coating a second conductor onto selective portions of the grooves that resemble a saw tooth shape in a profile view. The plurality of wedges created by the second conductor of the current layer and the first conductor of an adjacent layer are oriented more or less laterally with respect to the non-conducting layer. The wedges produce equal and opposite torque forces on the wedge faces that can be decomposed into equal and opposite forces that cancel out and forces that add up in the direction of the wedge dihedral angle bisector away from the wedge vertex. In various different propulsion embodiments the matrix material may be of low-density material with low dielectric. Examples could include but not be limited to of such materials as: polyethylene, polystyrene, and/or polypropylene. For propulsion embodiments such as rotary embodiments for power generation, low density in the non-conductor is not as important. An example of an additional non-conductor could include but not be limited to: Teflon. Also, in various different propulsion embodiments the coating for the first and second conductors may be formed but not limited to any of the following preferably low density conductors or their alloys: lithium, beryllium, magnesium and aluminum. For non-propulsion embodiments such as rotary embodiments for power generation, low density in the conductor is not as important. Examples of additional conductors could include but are not limited to: titanium, cobalt, nickel, copper, molybdenum, silver, lead, tantalum, tungsten, gold and/or platinum.

In a second embodiment the wedges may be formed by creating a plurality of nano-scale sinusoidal shaped grooves on one side of a sheet of non-conducting matrix material. A first conductor is coated onto a flat opposite side of the matrix material. A second conductor is coated onto selective portions of the grooves that resemble a sine curve shape in a profile view. The plurality of wedges created by the second conductor of the current layer and the first conductor of an adjacent layer are oriented more or less laterally with respect to the non-conducting layer. The wedges produce forces in the direction of the opening of the wedges. Properties of the matrix material and the conducting material are the same as in the first embodiment.

In a third embodiment the wedges may be formed by creating a plurality of nano-scale free form shaped grooves on one side of a sheet of non-conducting matrix material. The free form groove has a cross section with a monotonic descending slope from peak to valley of the groove and a monotonic ascending slope from valley to next peak. Peaks and valleys may or may not have intermediate surfaces with zero slopes. A first conductor is coated onto a flat opposite side of the matrix material. A second conductor is coated onto selective portions of the grooves that resemble a free form groove shape in a profile view. The plurality of wedges created by the second conductor of the current layer and the first conductor of an adjacent layer are oriented more or less laterally with respect to the non-conducting layer. The wedges produce forces in the direction of the opening of the wedge. Properties of the matrix material and the conducting material are the same as in the first embodiment.

For the three embodiments thus far mentioned, the second conductor at the groove peak of the current layer may optionally be separated from the first conductor of the adjacent layer by a thin, in relation to groove dimensions, layer of additional matrix material.

Additional embodiments may be obtained by forming wedges with a plurality of nano-scale grooves comprised of V-shaped, sinusoidal or free form profiles just previously described on both sides of a sheet of non-conducting matrix material and are described subsequently.

Normally Oriented Wedges

Additional embodiments may be obtained by creating a plurality of nano-scale grooves having V-shaped, sinusoidal or free-formed profiles on one side of a sheet of conducting material. The wedges thus created are normal to the conducting layer with the external forces thus produced also being more-or-less normal to the sheet of conducting material. An un-grooved layer of non-conducting material separates each layer of grooved conducting material.

Aggregating Forces

Because the external forces thus produced by any of the embodiments disclosed herein add up, the asymmetric external force for each wedge cavity can be aggregated to produce a larger continuous force for a layer of cavities. In the case of laterally oriented wedges, two or more suitably coated non-conducting matrix layers can be further aggregated to produce a bundle of layers that can be either left leaning or right leaning. In the case of normally oriented wedges, two or more couples of grooved conductor layer and non-grooved non-conducting layer the may be further aggregated to produce a bundle of layers.

One or more bundles of layers may be further aggregated to produce a layered force cell. Bundles may be arranged such that left and right-leaning forces cancel out or are reduced. Only the somewhat diminished forces in the direction of the matrix material remain in the case of laterally oriented wedges or forces perpendicular to the conducting sheet remain in the case of normally oriented wedges. Aligning all the forces in each bundle in the same direction may maximize forces.

For laterally oriented wedges, an alternate to the layered embodiment is the spiral/cylindrical embodiment in which the coated sheet of matrix material, whether having V-shaped, sinusoidal or free form shaped groove cross sections or whether any of these cross sectioned sheets have the optional thin spacer layer, may be tightly wound into a spiral of two or more turns creating a cylinder. One or more cylinders may be aggregated radially along the same cylindrical axis to form a spiral/cylindrical force cell embodiment. Because of cylindrical symmetry the right and left leaning nature of the forces automatically cancel out and the resulting force is aligned along the axis of the cylinder. The normally oriented wedge embodiments cannot be wound into spiral or cylindrical embodiments since all forces would point either toward or away from the axis of the spiral or cylinder.

Force cells, whether layered or spiral/cylindrical in nature, or whether comprised of laterally oriented wedges or normally oriented wedges, can be arranged in balanced pairs of cells that can be parallel to produce an external thrust or anti-parallel to produce zero thrust or somewhere in between to produce an intermediate three. They may also be arranged circularly and may be oriented to produce maximum, zero or intermediate torque. The means and nature of the devices to control direction and magnitude of the thrust or torque output is application dependent.

Any of the force cell embodiments may be coated with a protective sheathing. Examples of such sheathing may be but not limited to: latex, neoprene, nylon or other suitable materials such as the matrix materials or combinations of the above. The purpose of the sheathing may be to maintain a vacuum or non-reacting gas, if such is desired, and to keep out contaminants. Examples of non-reacting gas may be but not limited to: nitrogen, helium and argon.

### BRIEF DESCRIPTION OF THE DRAWINGS

The description of the various example embodiments is explained in conjunction with appended drawings, in which:

FIG. 1 is a diagram showing the wedge geometry used for calculating external forces along the wedge angle bisector by means of the perfectly conducting wedge (PCW) theory;

FIG. 2 is a diagram showing the two wedges formed when an angular plate intersects a flat plate and the resulting lateral forces (in the x direction) calculated using the PCW theory;

FIG. 3A is a graph that plots PCW calculations for external force against wedge angle, for the wedge geometry shown in FIG. 1;

FIG. 3B is a graph that plots PCW calculations for lateral force (in the x direction) against wedge angle, for the two wedge geometry shown in FIG. 2;

FIG. 4 is a side view showing a portion of a sheet of matrix material formed in accordance with one embodiment of the present invention, having a flat first side, and a second side shaped to include a plurality of nano-scale grooves that resemble saw teeth;

FIG. 5 is a top view of the portion of the matrix material shown in FIG. 4;

FIG. 6 is the side view of FIG. 4, but shown after a first conductor has been coated onto the flat lower surface of the portion of matrix material, and a second conductor is coated onto selective portions of the grooves as well as an optional spacer layer of matrix material under the first conductor;

FIG. 6A is the side view of FIG. 4 showing valleys having optional intermediate surfaces with zero slope, and though not shown, peaks may also have optional intermediate surfaces with zero slope;

FIG. 7 is a top view of the coated matrix material portion shown in FIG. 6;

FIG. 8A shows laterally oriented wedges formed from multiple layers of coated matrix material portion shown in FIGS. 6-7, without the optional spacer layer;

FIG. 8B emphasizes the geometry of the conductors and shows the parameters used to calculate force;

FIG. 9 shows laterally oriented wedges being formed from multiple layers of coated matrix material portion shown in FIGS. 6-7, along with a new FIG. 6-7 layer in the process of being added, with the optional spacer layer;

FIG. 10 is a side view showing a portion of a sheet of matrix material formed in accordance with one embodiment of the present invention, having a flat first side, and a second side shaped to include a plurality of nano-scale grooves that resemble sinusoidal corrugations;

FIG. 11 is the side view of FIG. 10, but shown after a first conductor has been coated onto the flat lower surface of the portion of matrix material, and a second conductor is coated onto selective portions of the grooves as well as an optional spacer layer of matrix material under the first conductor;

FIG. 12 shows laterally oriented wedges being formed from multiple layers of coated matrix material portion shown in FIG. 11, along with a new FIG. 11 layer in the process of being added, without the optional spacer layer;

FIG. 13 shows laterally oriented wedges being formed from multiple layers of coated matrix material portion shown in FIG. 11 along with a new FIG. 11 layer in the process of being added, with the optional spacer layer;

FIG. 14 is a side view showing a portion of a sheet of matrix material formed in accordance with one embodiment of the present invention, having a flat first side, and a second side shaped to include a plurality of nano-scale grooves that resemble a free form shaped groove having monotone descending slope from peak to valley and monotone ascending slope from valley to next peak and peaks and alleys having optional intermediate surfaces with zero slopes;

FIG. 15 is the side view of FIG. 14, but shown after a first conductor has been coated onto the flat lower surface of the portion of matrix material, and a second conductor is coated onto selective portions of the grooves as well as an optional spacer layer of matrix material under the first conductor;

FIG. 16 shows laterally oriented wedges being formed from multiple layers of coated matrix material portion shown in FIG. 15, along with a new FIG. 15 layer in the process of being added, without the optional spacer layer;

FIG. 17 shows laterally oriented wedges being formed from multiple layers of coated matrix material portion shown in FIG. 15, along with a new FIG. 15 layer in the process of being added, with the optional spacer layer;

FIG. 18 is a top view of a bundle of layers having grooves aligned along the y axis or nearly so and groove side profiles in accordance FIG. 6, FIG. 11 or FIG. 15;

FIG. 19 is a side view of a bundle of layers having side profiles in accordance FIG. 6, FIG. 11 or FIG. 15;

FIG. 20 is a side view of multiple bundles of layers shown in FIG. 19 making up a layered force cell and further showing the effect of Lateral, Normal and left and right leaning forces;

FIG. 21 is a top view of the layered force cell shown in FIG. 20 with protective sheathing;

FIG. 22 is a side view of the layered force cell shown in FIG. 20 with protective sheathing;

FIG. 23 is a front view of an unrolled spiral layer in the θ, z plane, having grooves aligned along the θ axis and groove side profiles in accordance FIG. 6, FIG. 11 or FIG. 15;

FIG. 24 is a side view of FIG. 23 in the r, z plane, having groove side profiles in accordance FIG. 6, FIG. 11 or FIG. 15;

FIG. 25 is a top view of a tightly rolled spiral layer in the r, θ plane, having grooves aligned along the θ axis and groove side profiles in accordance FIG. 6, FIG. 11 or FIG. 15;

FIG. 26 is a top view of multiple tightly rolled spiral layers having the appearance of concentric cylinders in the r, θ plane, comprising a spiral/cylinder force cell, having grooves aligned along the θ axis and groove side profiles in accordance FIG. 6, FIG. 11 or FIG. 15;

FIG. 27 is a side cross-section view of FIG. 26 in the r, z plane;

FIG. 28 is a top cross-section view of the spiral/cylindrical force cell shown in FIG. 26 with the addition of protective sheathing and a spindle core to wrap the layers around;

FIG. 29 is a front cross-section of the spiral/cylindrical three cell shown in FIG. 27 showing the protective sheathing and spindle core;

FIG. 30 illustrates a propulsion embodiment formed of a pair of balanced layered force cells showing the potential for left, right and axial aligned forces;

FIG. 31 illustrates a propulsion embodiment formed of a pair of balanced spiral/cylindrical force cells showing only axial aligned forces;

FIGS. 32A-32F illustrate a series of propulsion modalities based upon a pair of either layered spiral/cylindrical force cells;

FIG. 33A illustrates three force cells oriented perpendicular to a first axis in the tangential direction to provide maximum torque for the purpose driving a generator;

FIG. 33B illustrates three force cells oriented parallel to a first axis in the radial direction providing zero torque;

FIG. 33C illustrates a side view of the three force cells of FIG. 33A and/or FIG. 33B along with a block diagram illustrating a power generation application;

FIG. 34 shows scaling from micro level to macro level;

FIG. 35A is a set of plots comparing the thrust to weight ratio of a unit volume, for each of the following configurations: grooves on a single side of non-conducting matrix material, grooves on both sides of non-conducting matrix material and grooves on a single side of conducting material. The conducting material for the three plots was aluminum with density 2.7 gm/cm³. All plots are in terms of the unit volume thickness;

FIG. 35B shows thrust to weight ratio in terms of unit volume thickness for the normally oriented wedge embodiments for each of three conductor densities: a hypothetical alloy having a density of 1 g/cm³, aluminum with density 2.7 g/cm³ and gold having density of 19.32 g/cm³.

FIG. 36 is a top view showing a portion of a sheet of non-conducting matrix material formed in accordance with another embodiment of the present invention, having a plurality of nano-scale grooves on a first side thereof, and a plurality of nano-scale grooves on a second side, with the plurality of grooves on the second side being oriented at an angle with respect to the plurality of grooves on the first side;

FIG. 37 is a side view of the grooved non-conducting matrix material of FIG. 36;

FIG. 38 is the grooved non-conducting matrix material of FIG. 36, but is shown alter a first conductor has been coated onto selective portions of the grooves on the first side of the matrix material, and after a second conductor is coated onto selective portions of the grooves on the second side of the matrix material;

FIG. 39 is a side view of the grooved and coated non-conducting matrix material of FIG. 38, shown with required flat conducting layer(s) with an optional flat layer of matrix material between conducting layers prior to being joined with the grooved and coated matrix material; and

FIG. 40A shows laterally oriented wedges being formed from multiple layers of the grooved and coated non-conducting matrix material of FIG. 39 with the required conducting layer or coating and optional flat layer of non-conducting matrix material joined thereto, after having been rotted/layered to form a portion of three turns or layers of a force cell;

FIG. 40B shows more detail on a single unit volume displaying the parameters used in calculating force;

FIG. 41 is a top view showing a portion of a sheet of conducting material formed in accordance with one embodiment of the present invention, having a flat first side, and a second side shaped to include a plurality of nano-scale grooves having any of a saw-tooth, sinusoidal or free form cross-sectional profiles;

FIG. 42 is a side view of FIG. 41 showing the groove profiles;

FIG. 43 is side view of a layer of a non-conducting matrix material;

FIG. 44 shows normally oriented wedges being formed from multiple layers of the grooved conducting material of FIG. 42 interspersed with the non-grooved, non-conducting layers of FIG. 43.

### DETAILED DESCRIPTION OF THE INVENTION

As used throughout this specification, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “one or more of A, B, and C”, and “A, B, and/or C” mean all of the following possible combinations: A alone; or B alone; or C alone; or A and B together; or A and C together; or B and C together; or A, B and C together.

Also, the disclosures of all patents, published patent applications, and non-patent literature cited within this document are incorporated herein in their entirety by reference.

Any approximating language, as used herein throughout the specification and claims, may be applied to modify any quantitative or qualitative representation that could permissibly vary without resulting in a change in the basic function to which it is related. Accordingly, a value modified by a term such as “about” is not to be limited to the precise value specified, and may include values that differ from the specified value. In at least some instances, a numerical difference provided by the approximating language may correspond to the precision of an instrument for measuring the value. A numerical difference provided by the approximating language may correspond to a manufacturing tolerance associated with the aspect/featured being quantified, in which an overall tolerance for the aspect/feature may be derived from a stack up (i.e., the sum) of multiple individual tolerances.

Furthermore, the described features, advantages, and characteristics of any particular embodiment disclosed herein, may be combined in any suitable manner with any of the other embodiments disclosed herein.

It is further noted that any use herein of relative terms such as “top,” “bottom,” “upper,” “vertical,” and “horizontal” are merely intended to be descriptive for the reader, based on the depiction of those features within the figures for one particular position of the device/apparatus, and such terms are not intended to limit the orientation with which the device of the present invention may be utilized.

Cartesian (x, y, z) and cylindrical (r, θ, z) coordinates are included in numerous diagrams for convenience and context and are not intended to limit the orientation with which the device of the present invention may be utilized. All coordinate systems obey the right hand rule. A circle with a dot in the middle represents a vector coming out of the drawing. A circle with an X in the middle represents a vector going into the drawing.

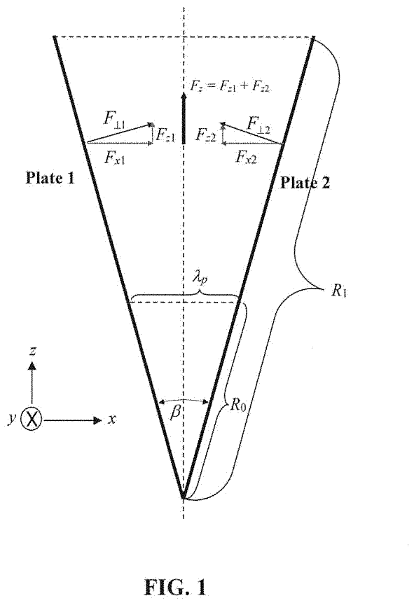

FIG. 1 through FIG. 3 pertains to the theoretical basis for the invention.

FIG. 1 is a diagram showing the wedge geometry used for calculating perpendicular forces to each plate by means of the perfectly conducting wedge (PCW) theory. These forces can subsequently be vectorially added to produce an external force along the wedge angle bisector.

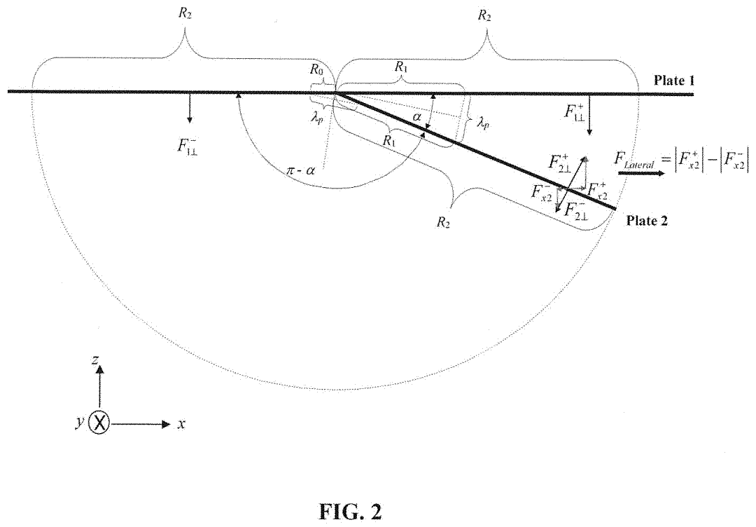

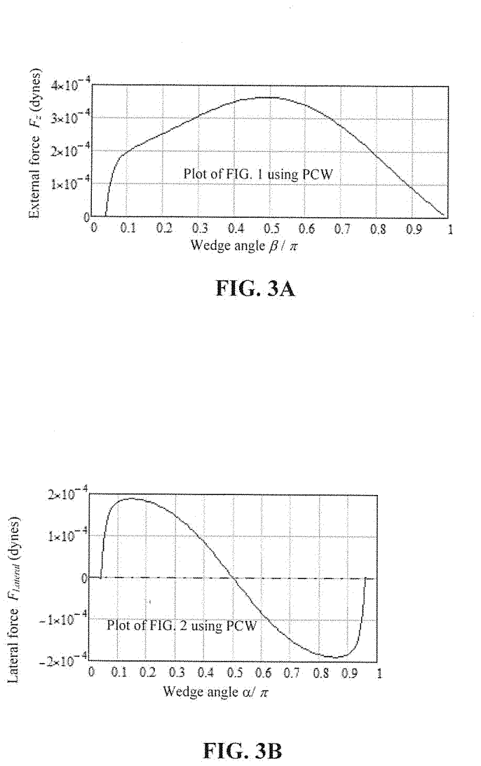

FIG. 2 is a diagram showing the two wedges formed when an angular plate intersects a flat plate and the resulting lateral forces (in the x direction) calculated using the PCW theory;

FIG. 3A is a graph that plots PCW calculations for external force along the direction of the wedge angle bisector against wedge angle, for the wedge geometry shown in FIG. 1;

FIG. 3B is a graph that plots PCW calculations for lateral force (in the x direction) against wedge angle, for the wedge geometry shown in FIG. 2;

Laterally Oriented Wedge Embodiments

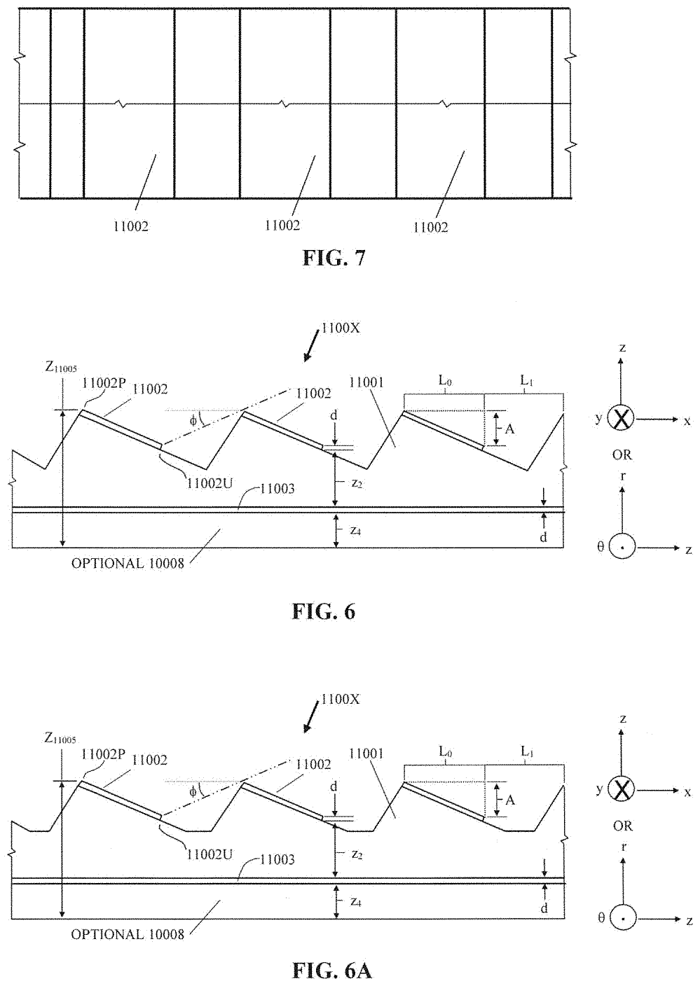

FIG. 6, FIG. 11 and FIG. 15 depict in cross-section particularly formed and coated nano-scale grooves formed in accordance with the presently disclosed technology that can be aggregated first into layers and then multiple layers into bundles and then multiple bundles into a layered force cell. Alternately the particularly formed and coated nano-scale grooves can be aggregated into a single layer that can be wound tightly around a spindle to form a cylindrical substructure and multiple cylindrical substructures can be aggregated to form a spiral/cylindrical force cell.

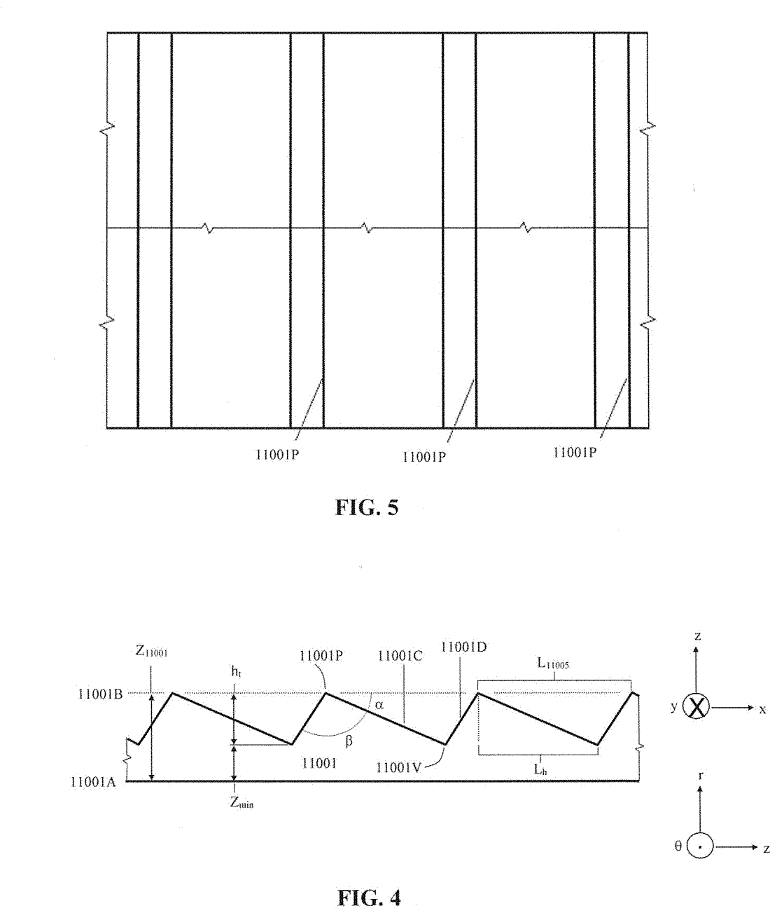

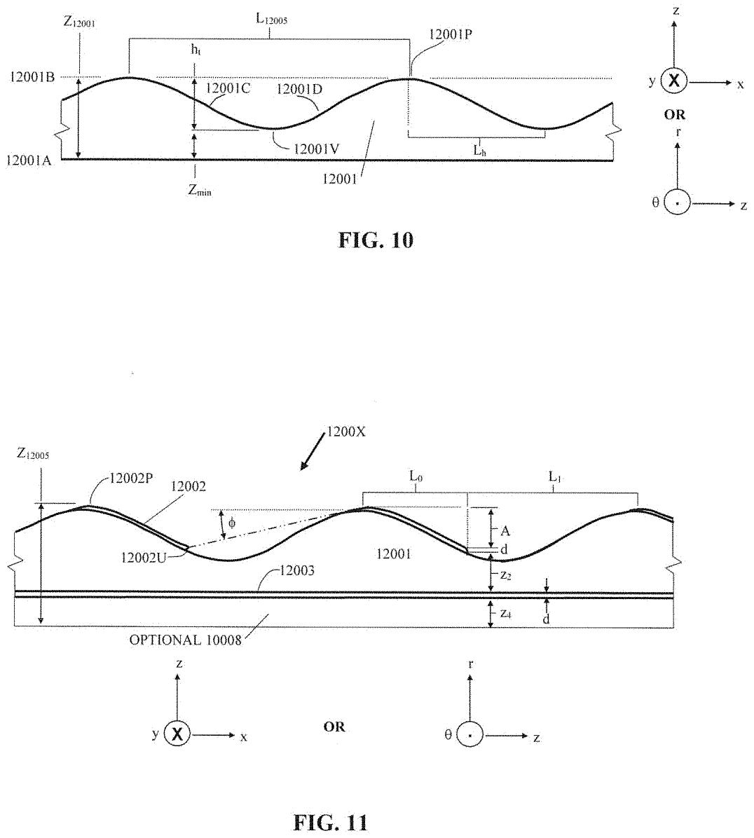

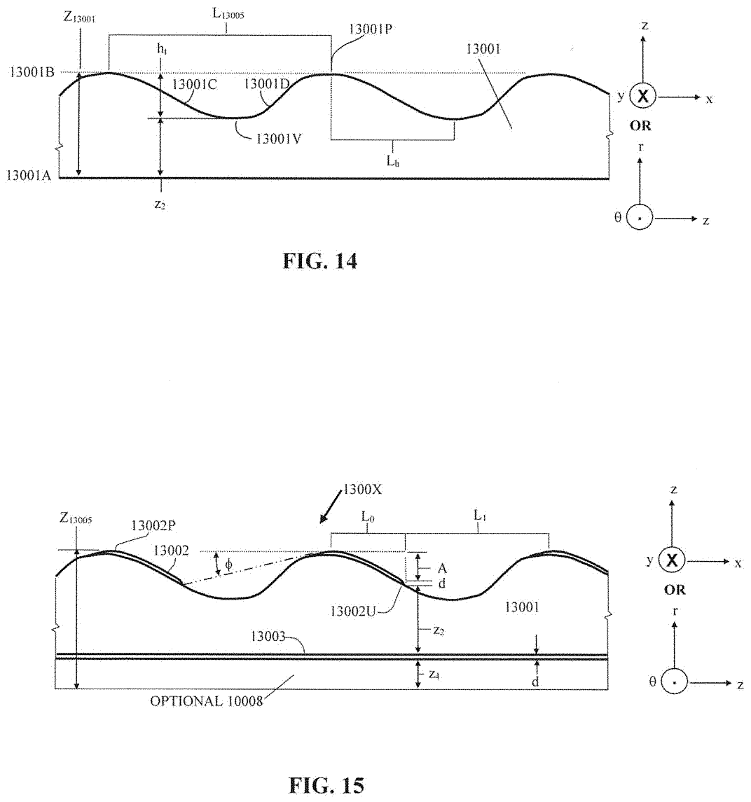

FIG. 4, FIG. 10, FIG. 14 are side views showing a sheet of non-conducting matrix material 11001, 12001, 13001 respectively that form a single layer with thickness Z₁₁₀₀₁, Z₁₂₀₀₁, Z₁₃₀₀₁ respectively and which provides the structure to hold the cavities in place. They are non-conductors with low density and low dielectric and magnetic permeability constants. As indicated by the break lines on the sides of the sheet shown in the top view of FIG. 5, the sheet may be as long as desired/required for the force cell, having thousands or even millions or more grooves formed therein, and the sheet may also be as wide as desired/required. Each layer of matrix material 11001, 12001, 13001 respectively may have a first side 11001A, 12001A, 13001A respectively which may be flat, and a second side 11001B, 12001B, 13001B respectively that may be formed with or have manufactured thereon, a plurality of nano-scale grooves each having a first side surface 11001C, 12001C, 13001C respectively and a second side surface 11001D, 12001D, 13001D respectively that may form a saw tooth shape, sinusoidal corrugation or free form groove respectively. Each of the grooves may have an apex 11001P, 120011P, 13001P at a first end of the surface 11001C, 12001C, 13001C respectively, and a valley 11001V, 12001V, 13001V at a second end of the first surface 11001C, 12001C, 13001C respectively creating a minimum thickness (zₘᵢₙ). The grooves may have an apex-to-apex spacing L₁₁₀₀₅, L₁₂₀₀₅, L₁₃₀₀₅ respectively and depth hₜ. The manufacturing method for forming the grooves may be similar to that used for production of a diffraction grating. Diffraction gratings can be manufactured using ruling engines, photolithographic techniques or impressions from a master template, and may produce from 500 or less to 2000 or more grooves per mm. Therefore, in one embodiment, L₁₁₀₀₅, L₁₂₀₀₅, L₁₃₀₀₅ respectively may be less than 500 nm to more than 2000 nm. Also, in one embodiment, the depth hₜ may be less than one micron, and in another embodiment, it may be less than ½ of a micron. The horizontal distance from apex to valley (11001P to 11001V in FIG. 4, 12001P to 12002V in FIG. 10 and 13001P to 13001V in FIG. 14) is Lₕ. Special to 11001, a blaze angle α is formed by the cross section profile of surface 11001C with the projection of 11001B from 11001B from 11001P to the next 11001P. The angle β between the first side surface 11001C and the second side surface 11001D at the apex 11001P may be roughly 90 degrees in one embodiment, and may be slightly larger or smaller in other embodiments. The free form shape groove (13001) is the general case and has monotone descending slope from apex 13001P to valley 13001V and monotone ascending slope from valley 13001V to next apex 13001P and apex and valleys having optional intermediate surfaces with zero slopes. (FIG. 6A shows optional intermediate valley surfaces with zero slopes. Optional intermediate peak surfaces with zero slope are also possible. Zero slope surfaces are surfaces that are parallel to first surfaces 11001A, 12001A and 13001A.) Grooves 11001 and 12001 are special cases of groove 13001.

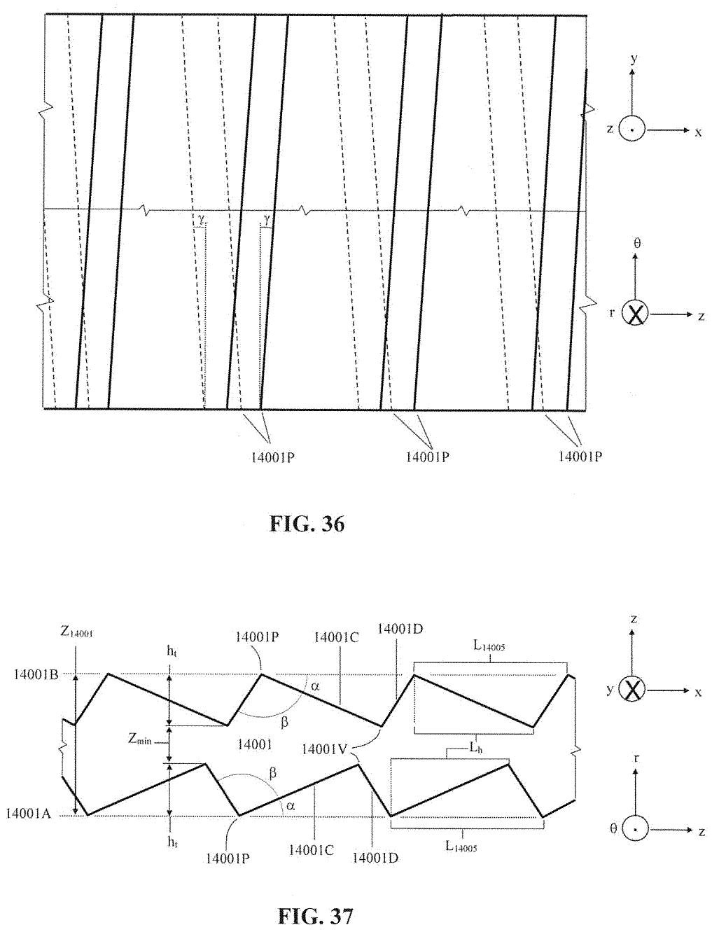

Note that while FIG. 4 shows saw-toothed grooves in the non-conducting matrix material 11001, the sinusoidal shaped corrugations and free-formed shaped grooves shown in FIGS. 10 and 14 for the matrix material 12001 and 13001 may instead be used in other embodiments. Also, in other embodiments, as seen in FIGS. 36-40, grooves may be used on both sides of the matrix material 14001, and the grooves may he oriented at an angle γ relative to each other in the x, y plane to bring strength and rigidity to system. (Note-conductor thickness d₁ may be greater than or equal to d, and crossing grooves at angle γ also allows d₁ to be thinner and to reduce or eliminate the need for the optional layer 10008). Calculations using the PFA show identical results between wedges resulting from saw-toothed shaped cavities and wedges created by partially metalizing sinusoidal corrugations for special cases when the metalized portion of the corrugation is half a corrugation wavelength and when both have the same amplitudes. Moreover similar manufacturing methods may be used for both.

In various propulsion embodiments the non-conducting matrix materials 11001, 12001, 13001 and 14001 may include but not be limited to: polyethylene with a dielectric of 1.2 to 2.3, and a density of about 0.88 to 0.96 g/cc; polystyrene with a dielectric of 2.4 to 2.7 and a density of 0.96 to 1.06 g/cc; polypropylene, with a dielectric of 1.6 to 2.4 and a density of 0.85 to 0.95 g/cc; polyvinyl chloride with dielectric 2.4 to 2.7 and density 1.1 to 1.45 g/cc. In a non-propulsion embodiment, the matrix materials may be but not limited to polytetrafluoroethylene (PTFE, Teflon®) with dielectric 2.0 and density 2.2 g/cc. (Note, all dielectric values are relative values where the dielectric constant for the vacuum is 1, and the dielectric constant for various materials ranges widely, such as: 80.4 for water; 5-10 for glass; 3.1 for mylar; 2.1 for Teflon; 1.43 for porous PTFE electronic substrates manufactured by the Porex Filtration Group; and 1.00059 for air at one atm—see e.g. “Comparison of Various Low Dielectric Constant Materials,” Yi-Lung Cheng, Chih-Yen Lee, Wei-Jie Hung, Ginn-Shim Chen, and Jau-Shiung Fang, Thin Solid Films, Volume 660, 30 Aug. 2018. Pages 871-878).

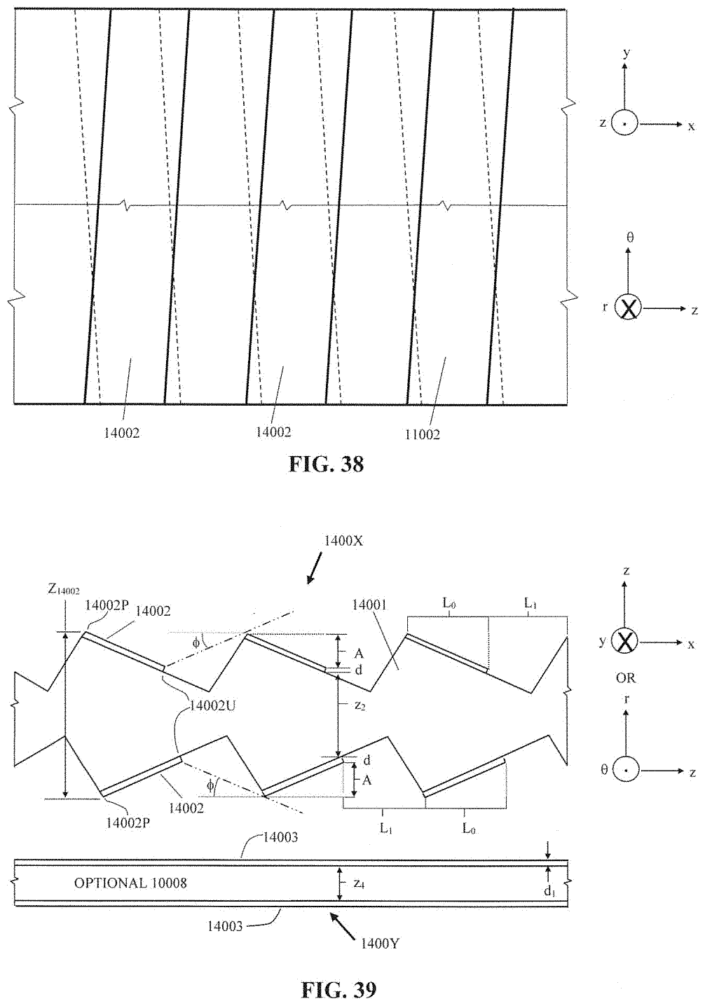

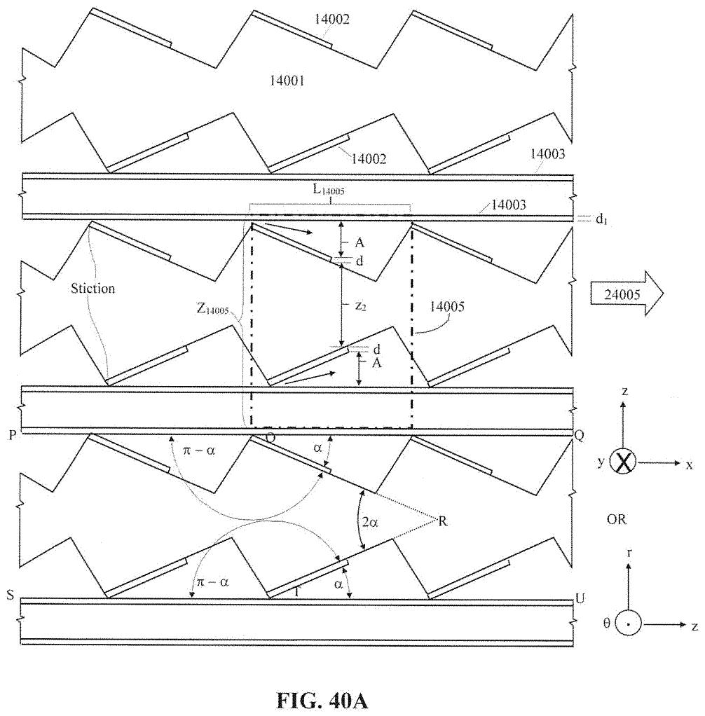

As seen in FIGS. 4 and 6, 10 and 11, 14 and 15 the non-grooved first surface 11001A, 12001A, 13001A respectively of the sheet of non-conducting matrix material 11001, 12001, 13001 respectively may be coated with a first conductor 11003, 12003, 13003 respectively with thickness d. As seen in FIG. 36 the first surface 14001A is grooved and selective portions of the groove are coated with conductor 14002. A second conductor 11002, 12002, 13002, 14002 respectively may he coated onto selective portions of each of the grooves of surface 11001B, 12001B, 13001B, 14001B, which coating may also have a thickness d. The second conductor 11002, 12002, 13002, 14002 respectively may be coated beginning at, or beginning proximate to, the apex 11001P, 12001P, 13001P, 14001P respectively of the groove in the matrix material, and may extend a distance toward the valley 11001V, 12001V, 13001V, 14001V respectively of the groove. In one embodiment the length of the conductor 11002, 12002, 13002, 14002 respectively coating may be controlledilimited by the angle that a source of the conductor in an evaporator may make with the projection of the plane defined by apex 11002P, 12002P, 13002P, 14002P respectively towards the next apex 11002P, 12002P, 13002P, 14002P respectively, Where the angle ϕ is not so limited, the coating 11002, 12002, 13002, 14002 respectively rainy extend closer towards the valley. In one embodiment, as seen in FIG. 6, FIG. 11, FIG. 15, FIG. 39 the horizontal distance L₁ from the end of the coating 11002U, 12002U, 13002U, 14002U respectively near the valley to the start of the coating at the adjacent apex 11002P, 12002P, 13002P, 14002P may be at least greater than the vertical height A between the end of the coating at the apex 11002P, 12002P, 13002P, 14002P respectively and the end of the same coating near the valley 11002U, 12002U, 13002U, 14002U respectively. In one embodiment the coating may be greater than 30 nm thick. In other embodiments, and depending upon the coating material that is used, and the degree to which is may become transparent, the thickness d may be greater than 10 nm. In the embodiment where first surface 14001A is grooved, an adjoining flat conducting surface may be provided by coating optional matrix layer 10008 having thickness z₄. If provided it may be coated on both sides with conductor 14003 having thickness d. Optional matrix layer 10008 may be eliminated if conductor 14003 has thickness d₁ greater than d such that the conducting layer can be self supporting or greater than approximately one quarter to one third the groove peak to peak distance.

As seen in FIGS. 6, 11 and 15 there may be an optional matrix layer 10008 beneath conductor 11003, 12003, 13003 respectively having a thickness z₄. This optional matrix layer is made of the same materials as 11001, 12001 and 13001. Any thickness of z₄ greater than the plasma wavelength (λₚ) is counter productive and still greater thickness can lead to a net zero force output. The plasma wavelength is the shortest wavelength photon, which will interact with the conductor. Photons with shorter wavelength tend to go through the conductor.

In different embodiments, the conductors 11002/11003, 12002/12003, 13002/13003, 14002/14003 should be good conductors. Since metals conduct electricity due to the fact that the outermost electrons in their atoms are held by weak forces, allowing electrons to flow easily from one atom to another, in the context of this disclosure all metals are good conductors. Some conventional density metallic conductors include lithium, aluminum, magneslin, titanium, and beryllium alloys. Some non-conventional low density metallic conductors include films that contain molecular metals as active components (see e.g., “New Flexible Low-Density Metallic Materials Containing the (BEDT-TTF)₂(IₓBr₁₋ₓ)₃ Molecular Metals as Active Components,” Elena Laukhina et al., Phys. Chem. B, 2001, 105 (45), pp 11089-11097). Other non-metallic materials may also be good conductors and may be used if their electrical conouctivity is similar to that of metals. Examples of some conductive non-metallic materials are doped silicon and germanium semiconductors, carbon, and polymers such as Ppy, PAni and PTh,

In different propulsion embodiments, the conductors 11002/11003, 12002/12003, 13002/13003, 14002/14003 may be formed of any of the following, or alloys thereof, with the goal of producing a low density coating material having low plasma wave length examples of which include but are not limited to: lithium (sp. gr. 0.534 at 20° C. λₚ: 150 to 205 nm), beryllium (sp. gr. 1.848 at 20° C., λₚ: N/A), magnesium (sp. gr. 1.738 at 20° C., λₚ: N/A), aluminum (sp. gr. 2.6989 at 20° C., λₚ: 80 to 100 nm). Note that the density of are substance in grams-per-cubic-centimeter is nearly the same numerically as its specific gravity. For non-propulsion embodiments such as rotary embodiments for power generation, low density is not as important. Examples of additional conductors include but are not limited to: titanium (sp. gr. 4.54, λₚ: N/A), cobalt (sp. gr. 8.9. λₚ: N/A), nickel (sp. gr. 8.9, λₚ: 110 to 150 nm), copper (sp. gr. 8.96, λₚ: 140 to 170 nm), molybdenum (sp. gr. 10.22, λₚ: N/A), silver (sp. gr. 10.5, ζₚ: 105 to 170 nm), lead (sp. gr. 11.35, λₚ: N/A), tantalum (sp. gr. 16.6, λₚ: N/A), tungsten (sp. gr. 19.3, λₚ: N/A), gold (sp. gr. 19.32, λₚ: 135 to 180 nm) and/or platinum (sp. gr. 21.45, λₚ: 210 to 280 nm).

In FIGS. 6, 11, 15 and 39 the cross-sections of the sub-assemblies of matrix materials, conductors and various groove shapes are 1100X, 1200X, 1300X and 1400X respectively and inherit all the characteristics and embodiments of their constituent pans.

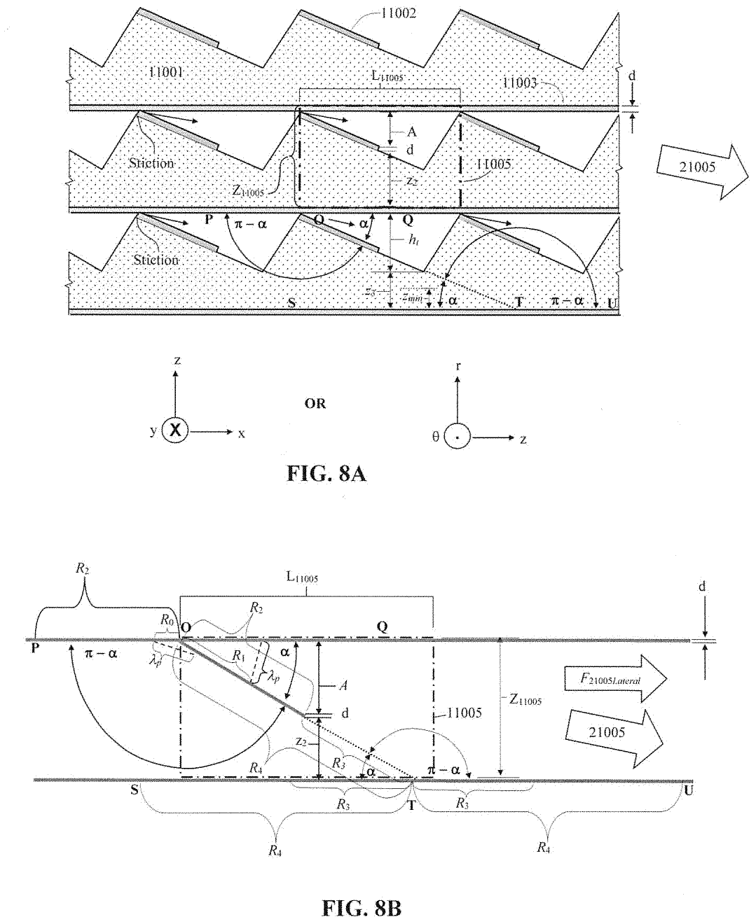

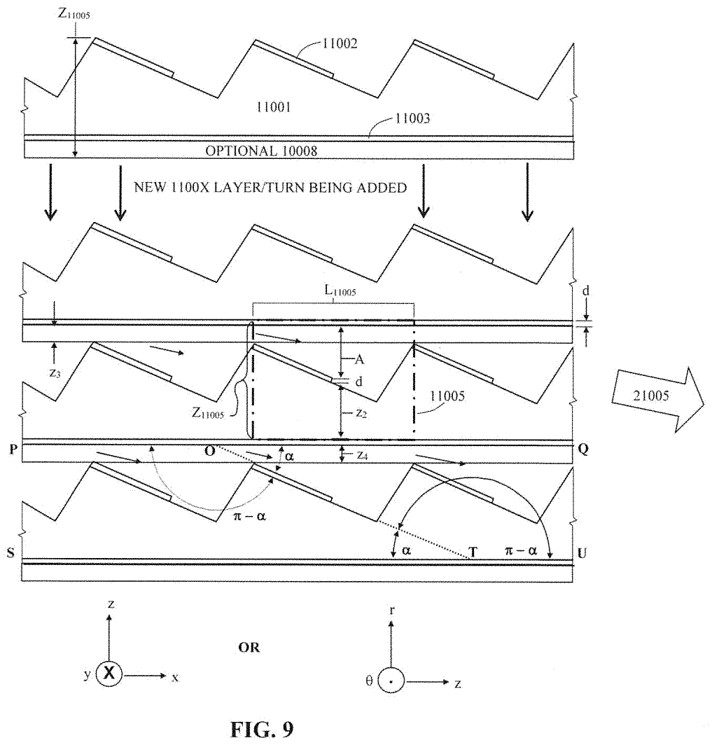

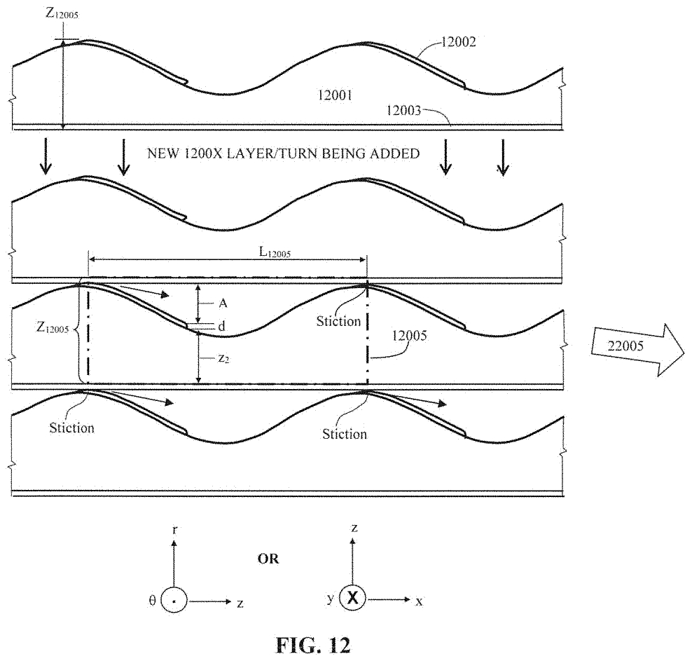

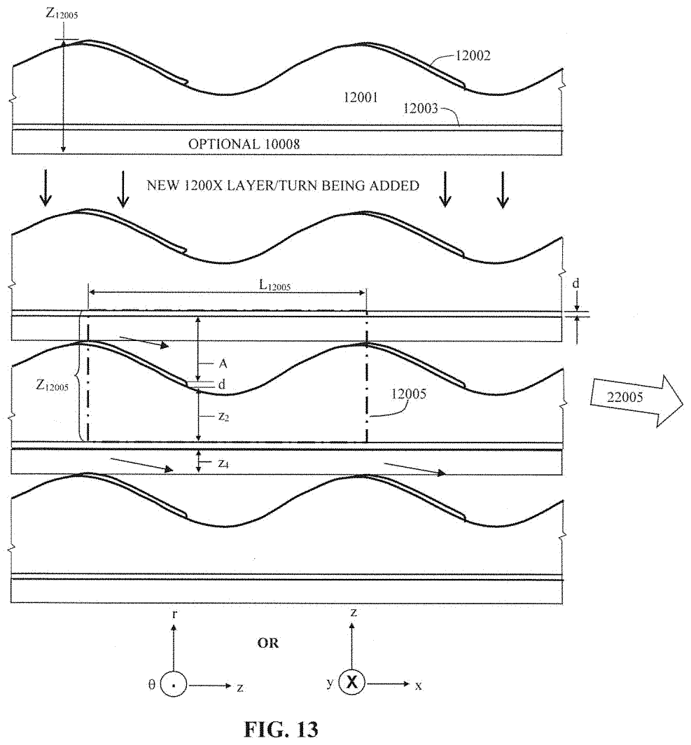

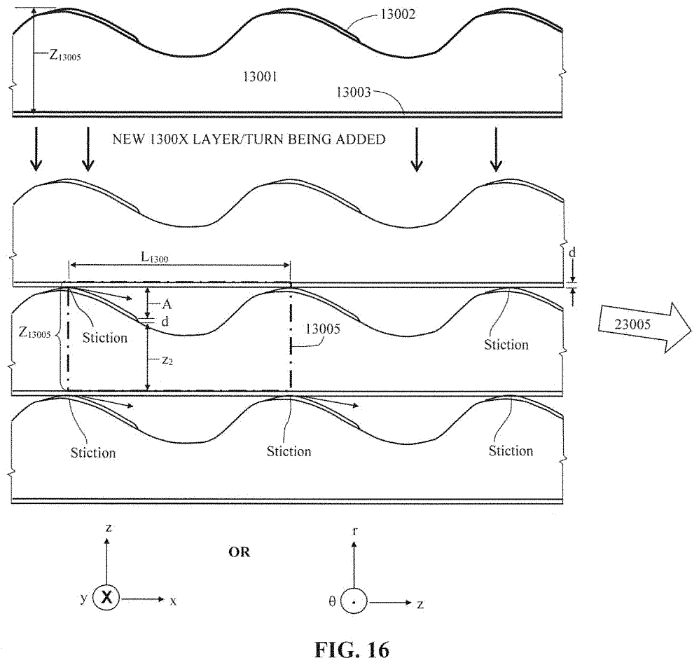

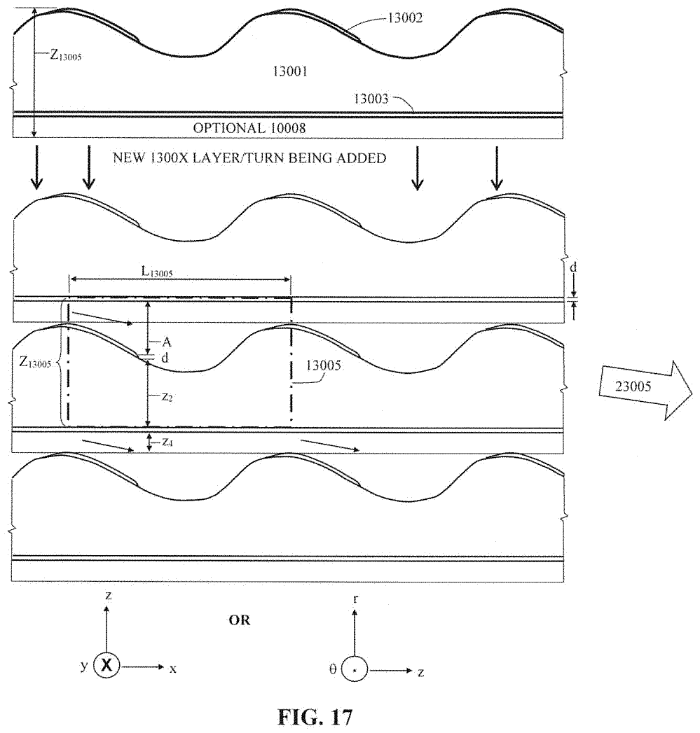

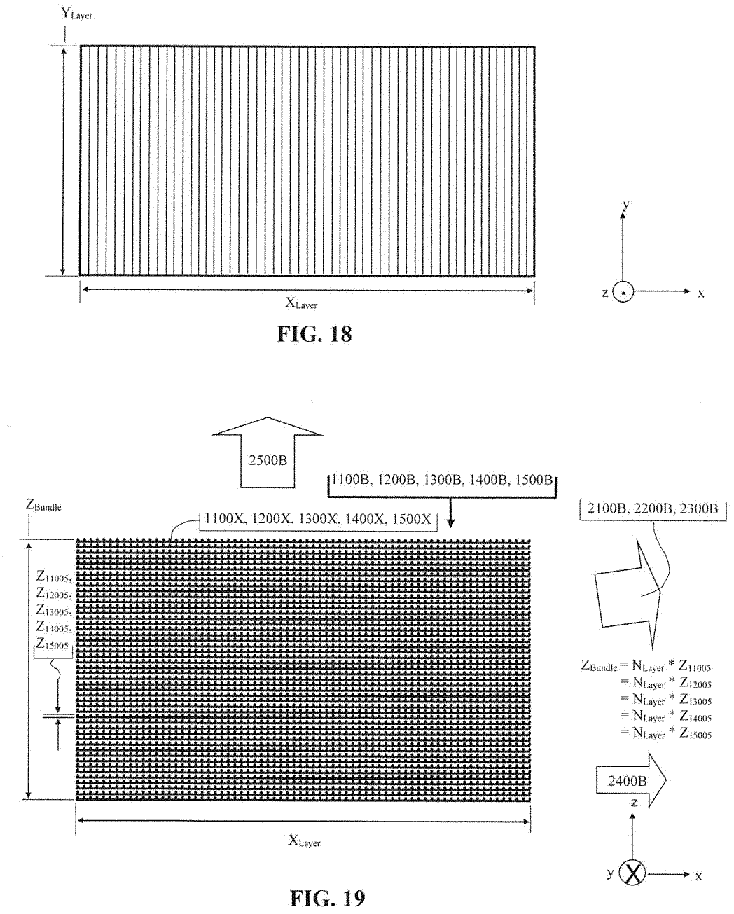

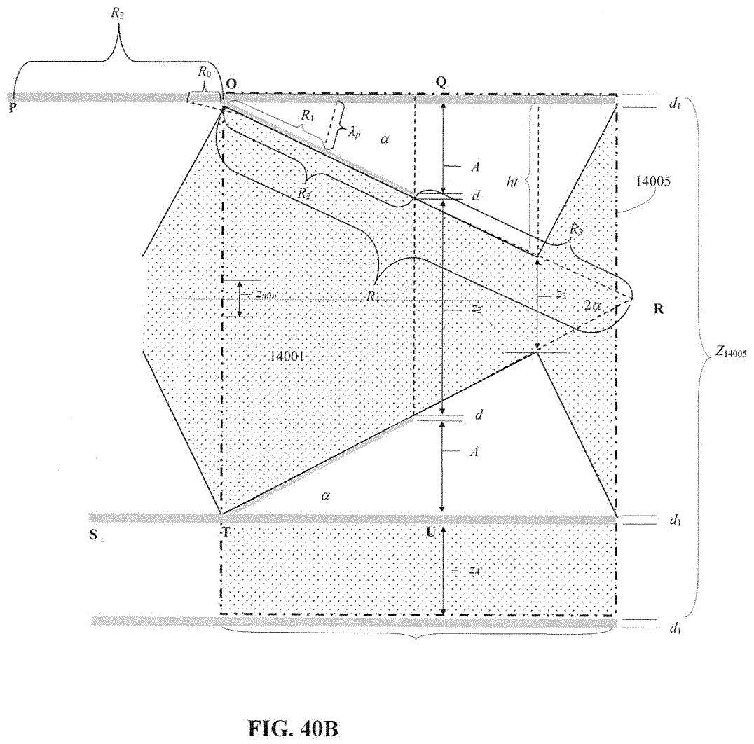

The cross-section of a unit volume with length L₁₁₀₀₅, depth Z₁₁₀₀₅ and width Y_{Layer} (see FIG. 18) is depicted with dashed lines in FIG. 8 and FIG. 9 as 11005. The cross-section of a unit volume with length L₁₂₀₀₅, depth Z₁₂₀₀₅ and width Y_{Layer} (see FIG. 18) is depicted with dashed lines in FIG. 12 and FIG. 13 as 12005. The cross-section of a unit volume with length L₁₃₀₀₅, depth Z₁₃₀₀₅ and width Y_{Layer} (see FIG. 18) is depicted with dashed lines in FIG. 16 and FIG. 17 as 13005. The cross-section of a unit volume with length L₁₄₀₀₅, depth Z₁₄₀₀₅ and width Y_{Layer} (see FIG. 18) is depicted with dashed lines in FIG. 40 as 14005.

The boundaries of Casimir cavities shown in FIG. 8A,B, 12, 16 and 40A,B are defined by that part of second conductors in a first layer 11002, 12002, 13002 and 14002 respectively that are below that part of first conductors 11003, 12003, 13003 and 14003 respectively in a next higher layer. The space between the boundaries may be vacuum (with a density of zero and relative dielectric of 1), a non-reactive gas with a density and dielectric constant close to that of vacuum examples of which include but are not limited to: nitrogen, helium and argon. Alternately, space between boundaries may be filled with more matrix material. Vacuum is the preferred embodiment followed by non-reactive gas.

The boundaries of Casimir cavities shown in FIGS. 9, 13 and 17 are defined by that part of second conductors in a first layer 11002, 12002 and 13002 respectively that are below that part of first conductor 11003, 12003 and 13003 respectively in a next higher layer. In this embodiment optional matrix material 10008 is part of the cavity. The space below matrix material 10008 but above 11002, 12002 and 13002 may be vacuum (with a density of zero and relative dielectric of 1), a non-reactive gas with a density and dielectric constant close to that of vacuum examples of which include but are not limited to: nitrogen, helium and argon. Alternately, space between boundaries may be filled with more matrix material. Vacuum is the preferred embodiment followed by non-reactive gas.

Conductor 11002 is shown touching conductor 11003 in FIG. 8, 12002 is shown touching conductor 12003 in FIG. 12, 13002 is shown touching conductor 13003 in FIG. 16 and 14002 is shown touching conductor 14003 in FIG. 40 which may provide stiction to prevent layers from moving relative to one another. (Note that the coated sheet of matrix material may be manufactured into a force cell in a vacuum, for vapor deposition of the coatings and stiction to occur).

In FIG. 1 the active part of the wedge starts where the length of a line perpendicular to the wedge angle bisector, which intersects both conductors of the wedge, is the plasma wavelength distance λₚ. The distance from the wedge vertex to these intersections is a parameter for determining force output. The same construct is uses in the laterally oriented wedges of FIG. 8B and FIG. 40B.

The amplitude A is the maximum perpendicular distance from conductor 11003 to conductor 11002 in FIG. 8A,B and FIG. 9, 12003 to 12002 in FIG. 12 and FIG. 13, 13003 to 13002 in FIG. 16 and FIG. 17 and 14003 to 14002 in FIG. 40A,B within the same wedge.

The distance z₂ is the maximum perpendicular distance from conductor 11003 to conductor 11002 in FIG. 8A,B and FIG. 9, 12003 to 12002 in FIG. 12 and FIG. 13, 13003 to 13002 in FIG. 16 and FIG. 17 in the adjoining wedge. In FIG. 40 the shortest distance from conductor 14002 in the top groove of a layer to conductor 14002 in the bottom groove of the same layer is z₂.

Unit volume 11005 produces external force 21005, unit volume 12005 produces external force 22005, unit volume 13005 produces external force 23005 and unit volume 14005 produces force 24005 in FIGS. 8A,B, 12, 13, 16, 17 and 40A,B respectively.

Particular to FIGS. 8A,B and 9 where the conducting materials 11002 and 11003 form simple wedges and the perfectly conducting wedge theory can be applied, angle QOT has value α, angle POT has value π-α, angle OTS has value α and angle OUT has value π-α. Similarly for FIG. 40A,B, where conductors 14002 and 14003 form simple wedges, angle QOR has value α, angle POR has value π-α, angle RTU has value α, angle RTS has value π-α and angle ORT has value 2a.

Normally Oriented Wedge Embodiments

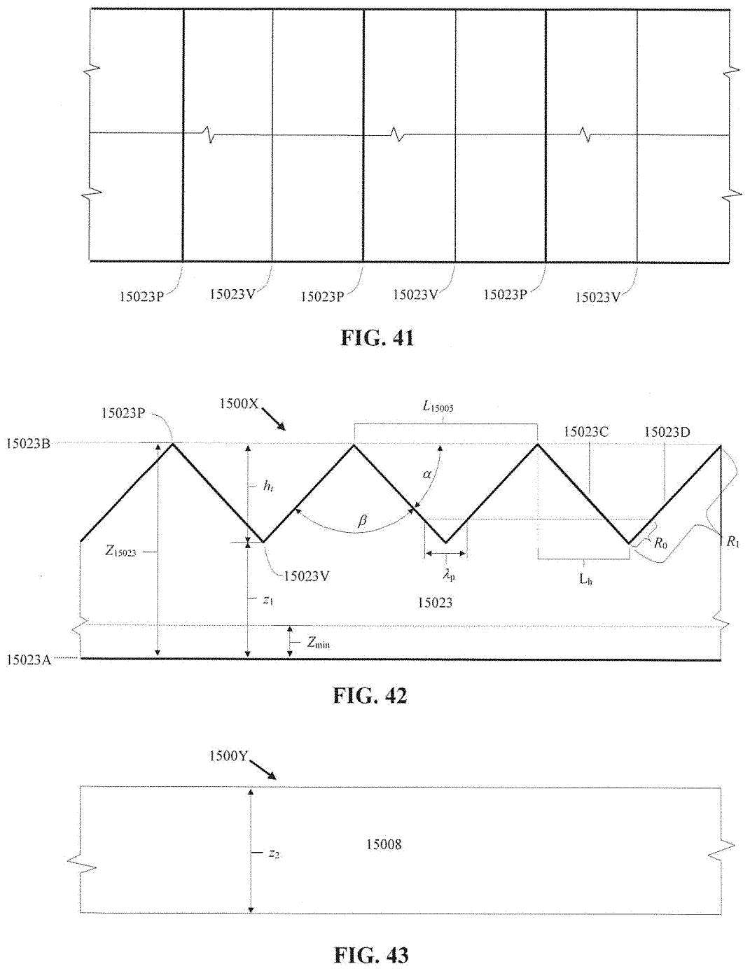

FIG. 41 through FIG. 44 depict in cross-section particularly formed nano-scale grooves formed in a conducting material in accordance with the presently disclosed technology interspersed with layers of non-conducting matrix material forming pairs that can be further aggregated first into layers and then multiple layers into bundles and then multiple bundles into a layered force cell. The wedges open in a direction perpendicular to the conducting material and are thus normally oriented wedges. As with laterally oriented wedges, normally oriented wedges may have groove profiles that are V-shaped, sinusoidal or free form.

FIG. 42 shows conducting material 15023 with V-shaped grooves in surface 15023B and flat surface 15023A. The V-shape is shown because it can be modeled by Perfectly Conducting Wedge theory. The grooves have peaks 15023P and valleys 15023V with groove depth of hₜ. The peak-to-peak distance is L₁₅₀₀₅. The distance between surface 15023B and surface 15023A is Z₁₅₀₂₃. The shortest distance between line 15023V and surface 15023A is z₁ with z₁ having a minimum distance, required for the integrity of conducting layer 15023, of Zₘᵢₙ. Distance Zₘᵢₙ may be approximately one quarter to one third of the distance L₁₅₀₀₅. Groove surfaces 15023C and 15023D are separated by dihedral angle β. The dihedral angle between the surface 15023B and surface 15023C is α. Conducting material 15023 should be a good conductor in the same way that 11002/11003, 12002/12003, 13002/13003, 14002/14003 are good conductors.

FIG. 43 shows non-conducting material 15008 with flat surfaces on both sides separated by distance z₂.

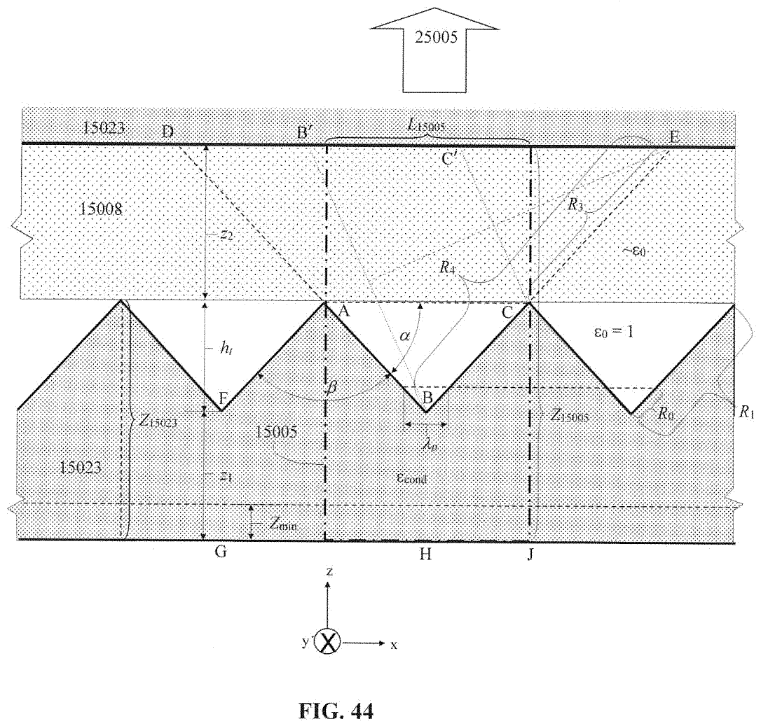

FIG. 44 shows unit volume 15005 with dimensions L₁₅₀₀₅, Z₁₅₀₀₅+z₂ and Y_{Layer} (not shown). Distance Y_{Layer} is a dimension of the force cell itself. In wedge ARC defined by angle β, the plasma wavelength (λₚ) determines the distance from the vertex B to the active part of the wedge as the length R₀. The distal wedge distance BC equals R₁. For simplicity distance BA equals distance BC. In wedge BEB′ defined by angle α, the thickness of the non-conducting layer 15008, which is z₂, determines the active part of the wedge. It starts at distance EC from vertex E, which equals distance EC′, which in turn equals distance R₃. By symmetry there is a edge corresponding BEB′ with vertex at D, that also has angle α and distance R₃. The distal distance R₄ equals the distances EB and EB′ with corresponding symmetric distances for the wedge with vertex at D. For most angles β, thicknesses of non-conductor 15008 greater than the plasma wavelength λₚ of the conducting material, result in a net positive force 25005 from unit volume 15005 as shown.

Formation of various different embodiments of a force cell in accordance with the presently disclosed technology is discussed in detail hereinafter.

Layered Force Cell Embodiments

FIGS. 18 and 19 shows a multiplicity of unit volumes 11005, 12005, 13005, 14005 or 15005 associated with sub-assemble cross-sections 1100X, 1200X, 1300X, 1400X and 1500X respectively, aggregated into a generally flat force cell where FIG. 18 shows a top view having dimensions X_{Layer} and Y_{Layer}. Multiple force cell layers may be further aggregated into a stack of force cell layers called a bundle, as illustrated in FIG. 19. The N_{Layer} (where N_{Layer} is greater than or equal to 2) times the unit volume depth (Z₁₁₀₀₅, Z₁₂₀₀₅, Z₁₃₀₀₅, Z₁₄₀₀₅and Z₁₅₀₀₅) is the thickness of the bundle Z_{Bundle}. The resulting sub-assemblies are then identified as 1100B, 1200B, 1300B, 1400B and 1500B depending upon cross-section type and producing bundle force 2100B, 2200B, 2300B, 2400B and 2500B. Bundle forces are directed at some angle (except for 2400B and 2500B which are perpendicular to bundle faces and are horizontal and vertical respectively).

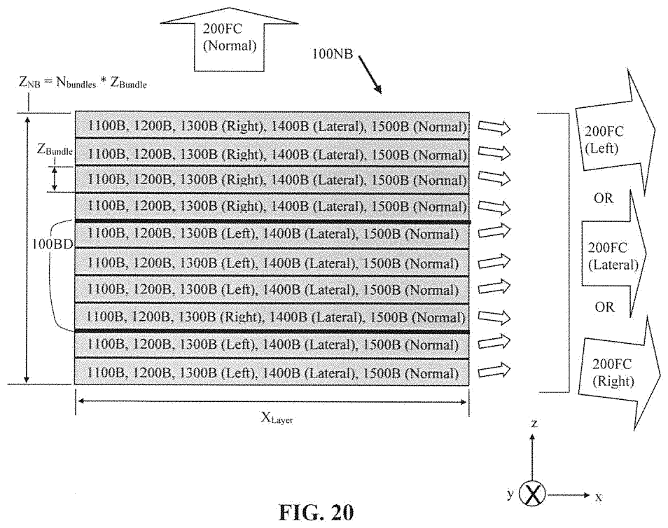

FIG. 20 shows the active part of the force cell comprised of a multiplicity of bundles further comprised of bundles of various cross-section types (1100B, 1200B, 1300B, 1400B or 1500B). The thickness or the bundle stack Z_{NB} equals N_{Bundles} (where N_{Bundles} is greater than or equal to 1) times the bundle thickness Z_{Bundle}. Bundle forces may be left leaning, right leaning depending upon the orientation of the grooves in the bundle or perpendicular to the bundle faces in the case of 1400B and 1500B. For the situation where two bundles may have grooves facing each other, a conducting layer 100BD may be inserted between them so that the forces that could be produced by the two facing layers are not lost. Conducting layer 100BD may be made of the same materials as conductors 11002, 11003, 12002, 12003, 13002, 13003, 14002, 14003 and 15023. Unlike the wedge conductors, which were coated onto a matrix material, 100BD must be strong enough to stand-alone. The bundle stack aggregation is identified as 100NB and produces force 200FC.

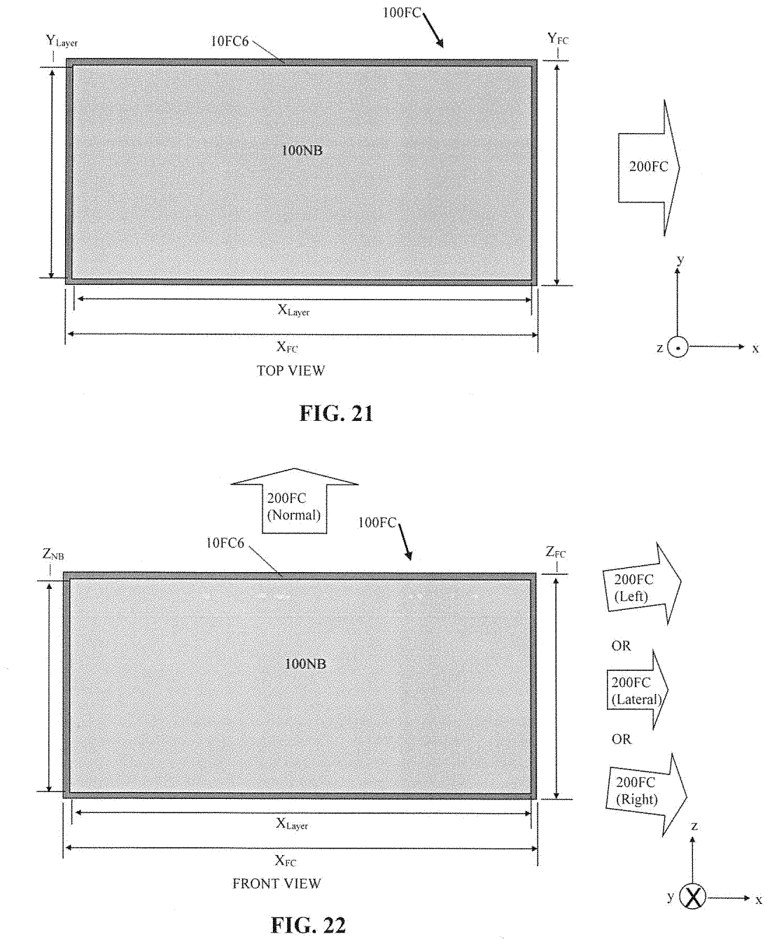

FIGS. 21 and 22 show top and front views respectively of a force cell having active portion 100NB and dimensions X_{FC}, Y_{FC} and Z_{FC}. The active portion may be coated with a protective sheathing 10FC6 and the entire ensemble is represented as 100FC and produces propulsive force 200FC. In various embodiments examples of various sheathing 10FC6 options include but are not limited to: latex with a density of 0.92 to 0.96 g/cc, neoprene with a density of 1.2 to 1.24 g/cc, nylon with a density of 1.1 g/cc or any of the matrix materials or combinations of the above materials. The purpose of the sheathing may be to maintain a vacuum or non-reacting gas, if such is desired, and to keep out contaminants. Examples of non-reacting gas may be but not limited to: nitrogen, helium and argon.

Spiral Force Cell Embodiments

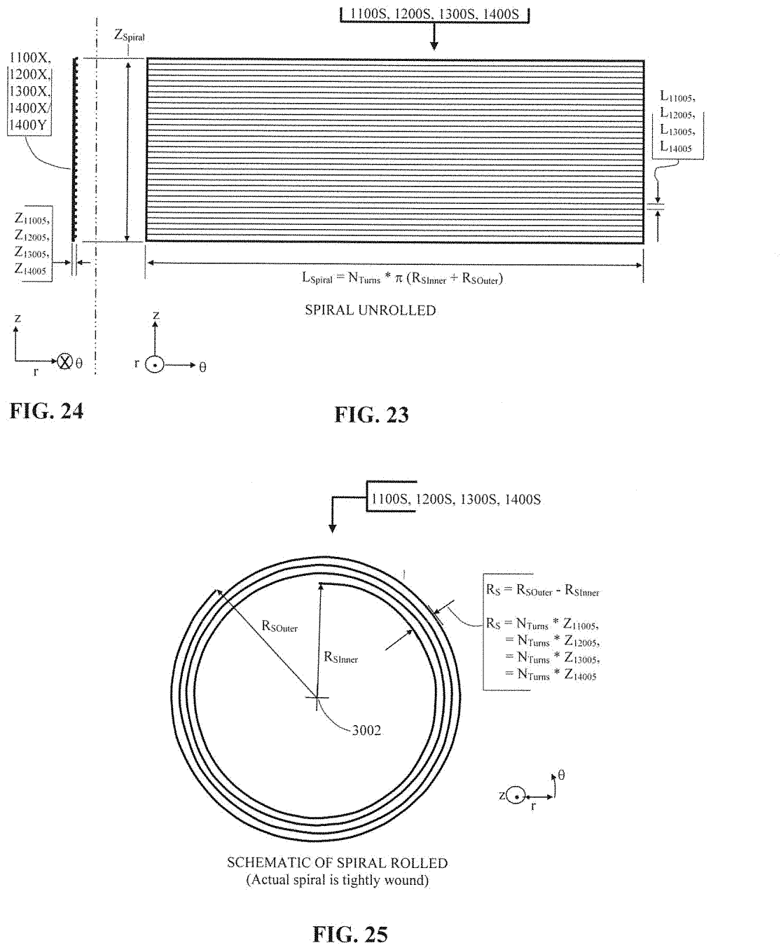

As shown in FIGS. 23, 24 and 25, the coated sheet of matrix material having grooved cross-sections 1100X, 1200X, 1300X and 1400X/1400Y may be roiled into a plurality of windings to form a spiral cross-sectional shape. FIG. 23 shows a front view of the spiral unrolled having length L_{Spiral}=N_{Turns} times π times (R_{SInner}+R_{SOuter}) and height Z_{Spital} with the grooves oriented in the θ direction. FIG. 24 is a side view with layer thickness Z₁₁₀₀₅, Z₁₂₀₀₅, Z₁₃₀₀₅ and Z₁₄₀₀₅ oriented in the r direction. FIG. 25 is a top view showing the spiral shape rolled around axis 3002 and having inner radius R_{SInner} and outer radius R_{SOuter} and difference of radii of R_{S}. Although the spiral appears loose in FIG. 25 in order to see the spiral shape, the spiral in actuality is tightly wound with conductors 11002, 12002 and 13002 in one layer touching conductors 11003, 12003 and 13003 in an adjoining layer, or alternately conductors 11002, 12002 and 13002 touching spacer layer 10008 in an adjoining layer (see FIGS. 8, 9 12, 13, 16 and 17), or conductor 14002 in 1400X touching conductor 14003 in 1400Y (see FIGS. 39 and 40). The tightly wound spirals thus formed are identified as 1100S, 1200S, 1300S or 1400S depending upon their groove shape and whether the matrix material is grooved on one side or two.

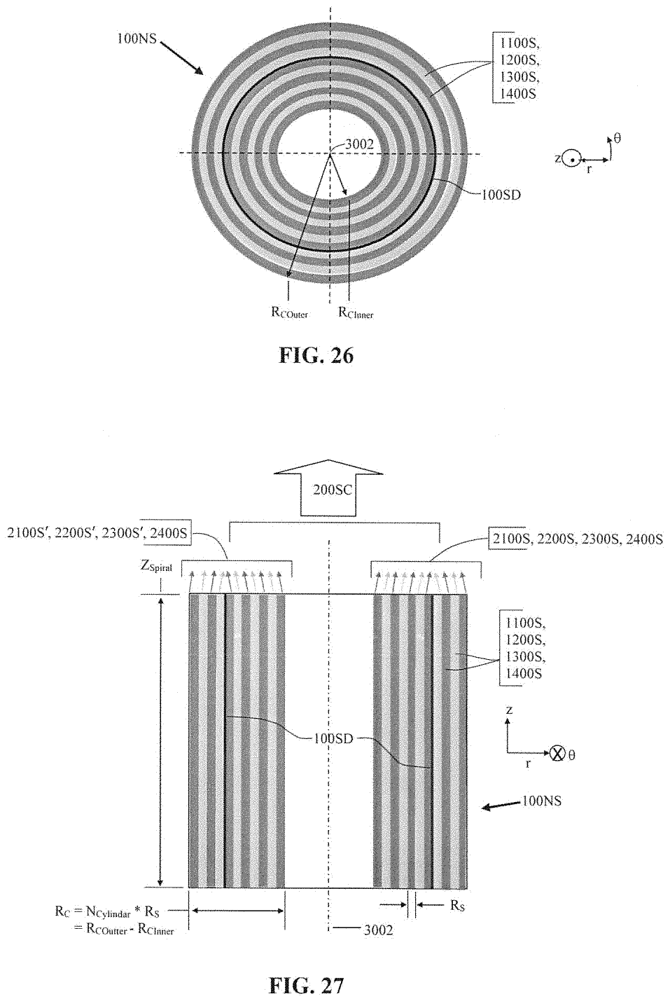

FIGS. 26 and 27 show how a multiplicity of concentric spirals having various groove cross-sections 1100S, 1200S, 1300S and 1400S formed around axis 3002 can be further aggregated to form the active part of a spiral/cylindrical force cell with inner radius R_{CInner} and outer radius R_{COuter} and radius difference R_{C} and height Z_{Spiral}. In situations where the outermost grooves of an inner spiral face the innermost grooves of an outer spiral, a conducting layer 100SD may be inserted between them so that the forces that could he produced by the two facing layers are not lost. Conducting layer 100SD may be made of the same materials as conductors 11002, 11003, 12002, 12003, 13002, 13003, 14002 and 14003. Unlike the wedge conductors, which were coated onto a matrix material, 100SD must be strong enough to stand-alone. The force cell aggregate thus formed is identified as 100NS and produces force 200SC.

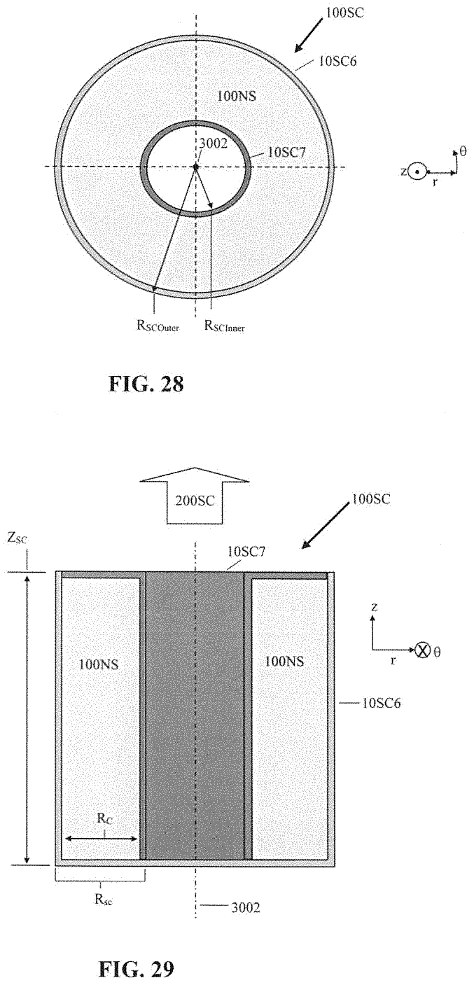

FIGS. 28 and 29 show top and front cross-sections of a spiral/cylindrical force cell identified as 100SC, formed around axis 3002. The active portion 100NS may have a protective sheathing 10SC6. In various embodiments examples of various sheathing 10SC6 options include but are not limited to: latex with a density of 0.92 to 0.96 g/cc, neoprene with a density of 1.2 to 1.24 g/cc, nylon with a density of 1.1 g/cc or any of the matrix materials or combinations of the above materials. The purpose of the sheathing may be to maintain a vacuum or non-reacting gas, if such is desired, and to keep out contaminants. Examples of non-reacting gas may be but not limited to: nitrogen, helium and argon. The active portion 100NS is formed around a spindle 10SC7. The spindle can be made of the same materials as the sheathing. The only restriction on the radius of the spindle is that it he strong enough to withstand the winding process. Force cell 100SC produces force 200SC.

Harnessing Force Cells for Propulsion

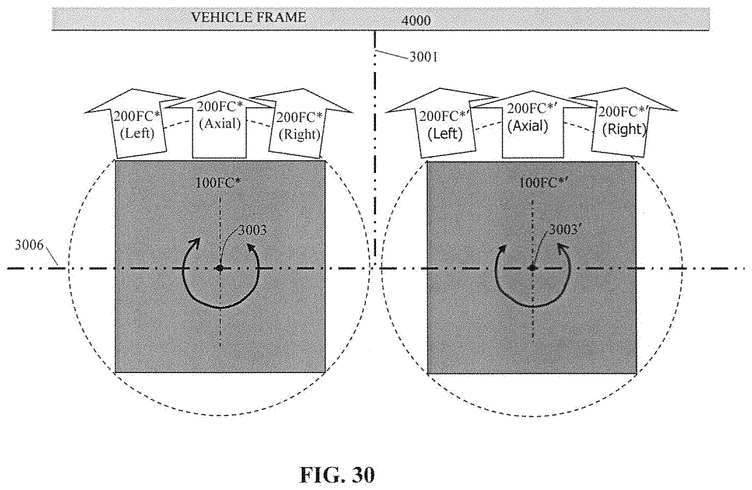

FIG. 30 shows an embodiment for propulsion purposes comprised of a pair of force cells 100FC* and 100FC*′. The asterisks mean that 100FC* and 100FC*′ are comprised of one or more standard sized force cells 100FC and 100FC′ respectively, having forces of the same magnitude and direction. Force cell 100FC′ is simply force cell 100FC rotated 180 degrees around the z-axis. The harness containing 100FC*, is attached to structural axis 3006, which in turn is attached perpendicularly to structural axis 3001, which in turn is attached to vehicle frame 4000. Force cell aggregates 100FC* and 100FC*′ produce propulsive forces 200FC* and 200FC*′ that may he symmetric around axis 3001. Force cell aggregates 100FC* and 100FC*′ can rotate and counter rotate by means or actuators (not shown) around axes 3003 and 3003′ respectively in such a way that the vector sum of forces 200FC* and 200FC*′ is along axis 3001, allowing for the collective force along axis 3001 to be directly measured with a sensor, not shown. In this embodiment, structure, actuators, sensors and controllers are not shown because they are possibly ‘off the shelf’ and application specific.

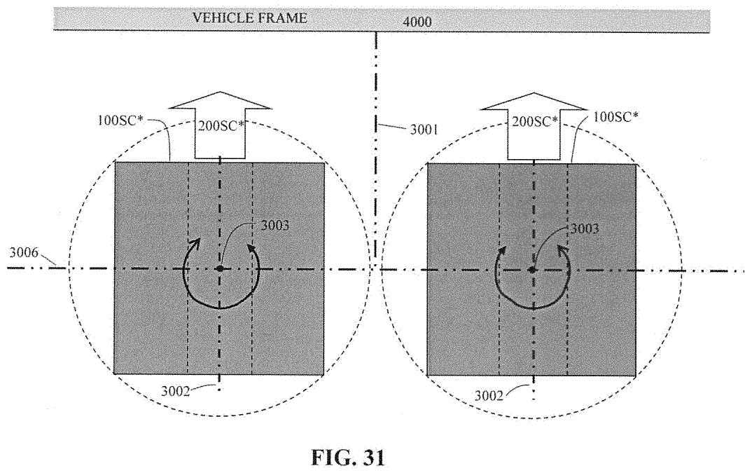

FIG. 31 shows a typical embodiment for propulsion purposes comprised of a pair of cylindrical force cells 100SC* that work analogously to the embodiment of flat-layered force cells depicted in FIG. 30.

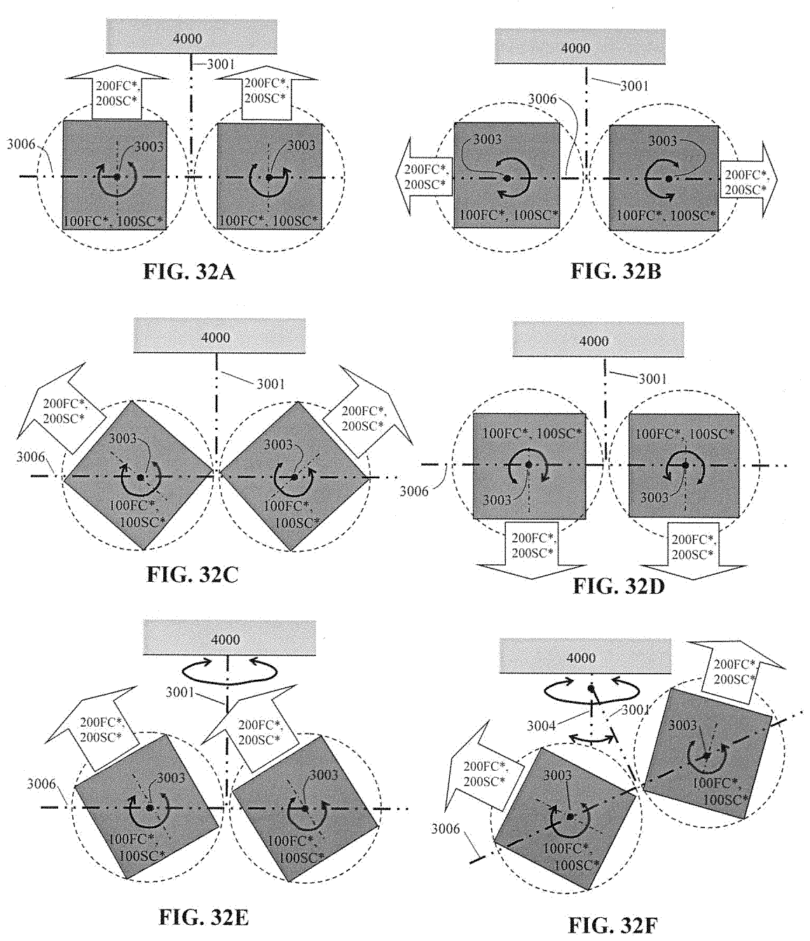

FIGS. 32A-32F show how various propulsion modalities can be obtained from the embodiment of FIGS. 30 and 31. FIG. 32A depicts maximum propulsion, FIG. 32B depicts zero propulsion. FIG. 32C depicts intermediate propulsion, FIG. 32D depicts reverse propulsion, FIG. 32E depicts single axis vectored propulsion and FIG. 32F depicts double axis vectored propulsion. Note that in the case of single axis vectored propulsion, forces 200FC* and 200FC*′ or alternately forces 200SC* and 200SC*′ do not add up in the direction of axis 3001 and thus must be calculated, but takes up less space. A variation of the arrangement shown in FIG. 32E would replace 100FC*′ (100SC*′) with another 100FC* (100FC*) and remove the swivel from axis 3001, directly connecting structural axis 3001 with rotational axis 3003, which would allow vectored propulsion in only one plane and would conserve space even more. Double axis vectored propulsion threes 200FC* (200SC*) and 200FC*′ (200SC*′) add up in the direction of 3001 and can be directly measured.

Harnessing Force Cells for Power Generation

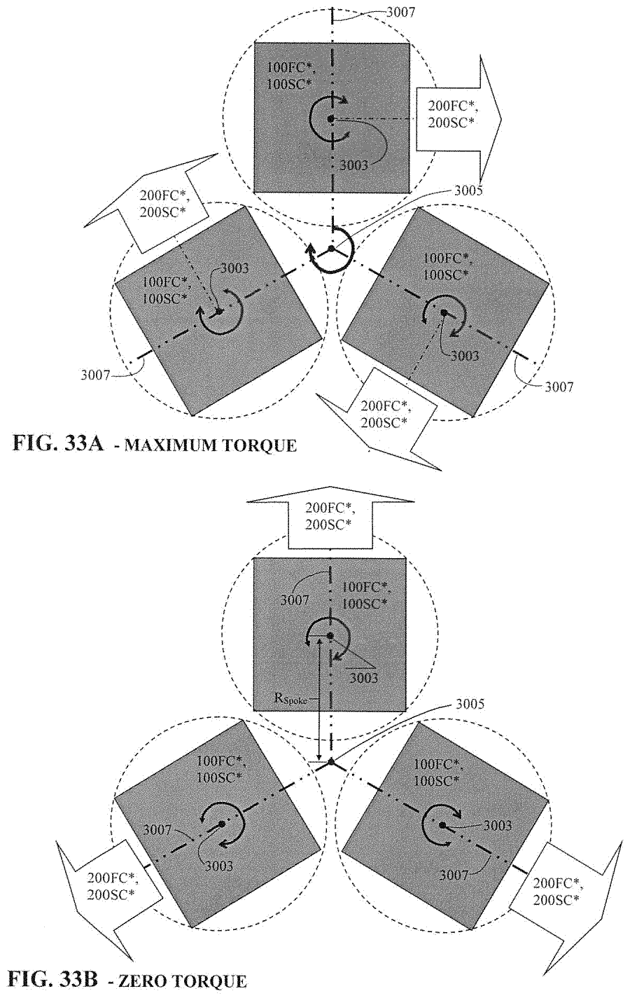

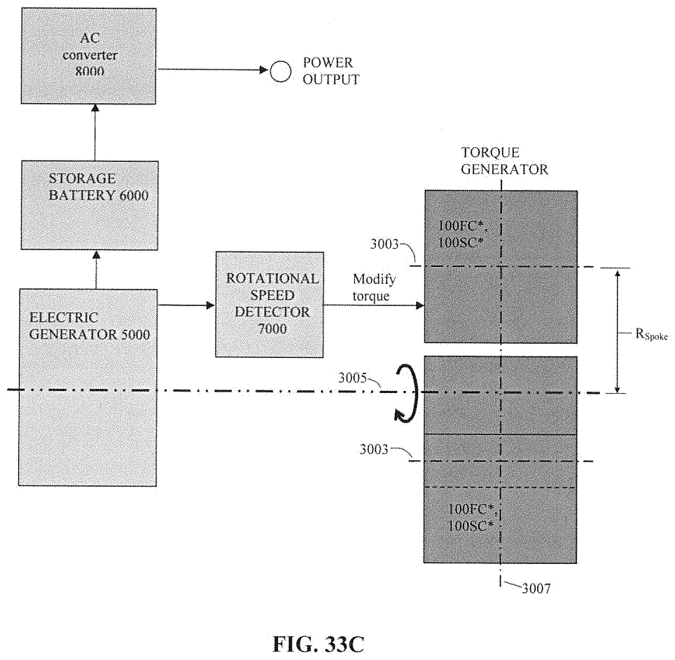

FIG. 33A-C depicts a typical embodiment of force cells, either flat 100FC or cylindrical 100SC, for power production. Shown in FIG. 33A, forces 200FC* (200SC*) are perpendicular to axes 3007 producing torque causing axis 3005 to rotate. In turn axis 3005 can be optionally connected to generator 5000. In FIG. 33B forces 200FC* (200SC*) are parallel to axes 3007 resulting in zero torque. The distance between axis 3005 and 3003 along axis 3007 is torque lever R_{Spoke}. Though only three torque levers are shown in this diagram any number of levers greater than two is possible, space permitting. Moreover, there is no limit on the number of torque lever lengths except rotational symmetry and space. FIG. 33C shows a block diagram showing how the torque generator of FIG. 33A and 33B incorporated into an electrical generation system.

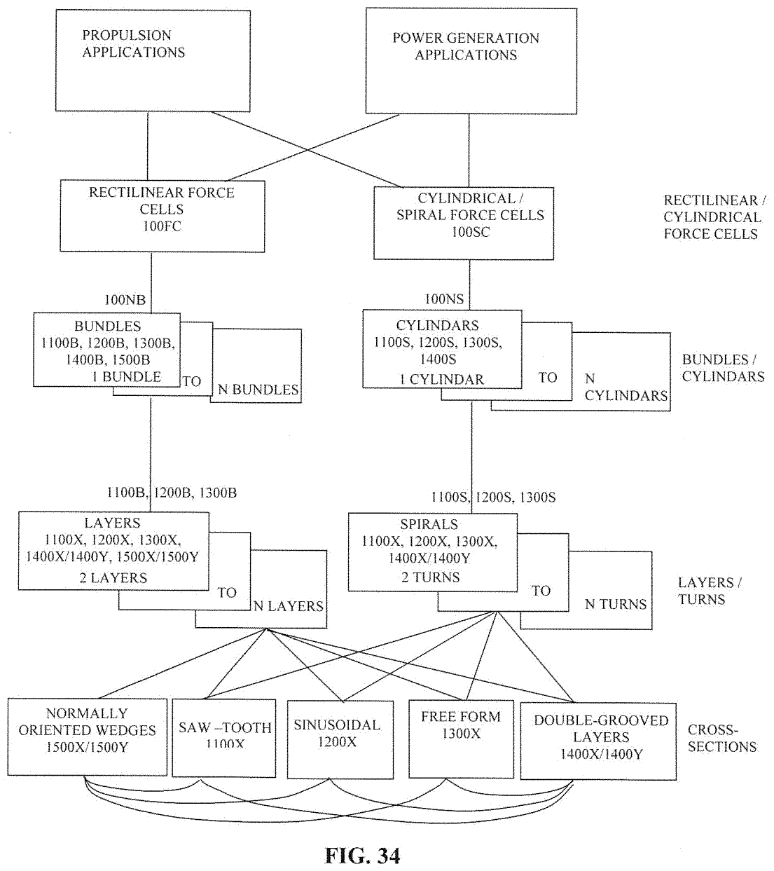

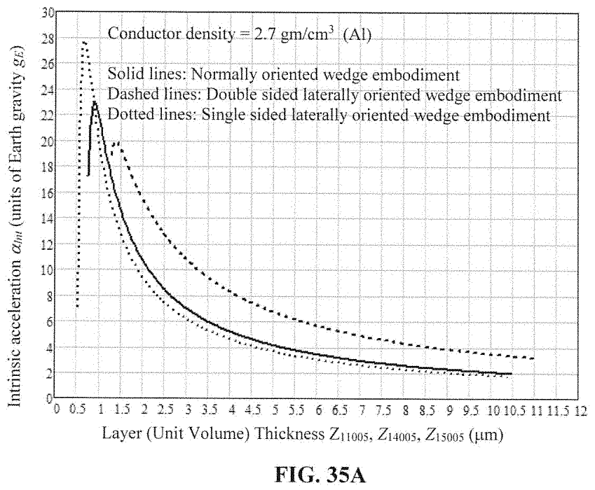

FIG. 34 shows an organizational diagram that shows the relationship between various embodiments and their sub-assemblies. Though FIGS. 38 to 44 show only a saw-tooth groove embodiment, groove shapes may be sinusoidal or free form as well.

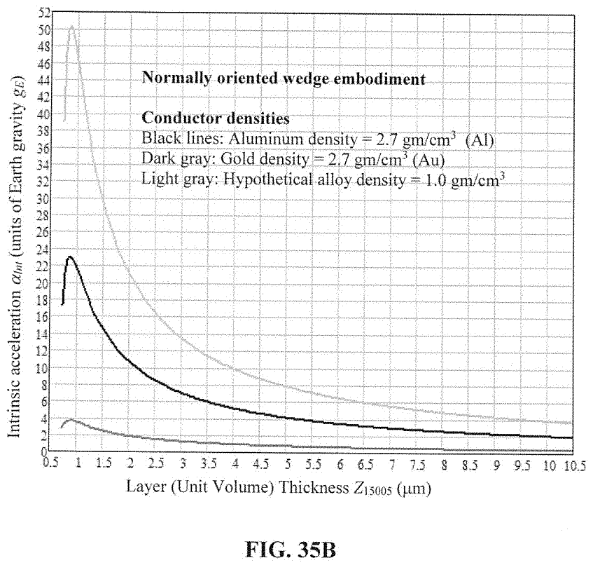

FIG. 35A is a set of plots comparing the thrust to weight ratio of unit volumes 11005, 14005 and 15005 expressed in units of Earth gravities, for each of the following configurations: grooves on a single side of non-conducting matrix material, grooves on both sides of non-conducting matrix material and grooves on a single side of conducting material. The conducting material for the three plots was aluminum with density 2.7 gm/cm³. All plots are in terms of the unit volume thickness;

FIG. 35B shows thrust to weight ratio in terms of unit volume thickness for the normally oriented wedge embodiments for each of three conductor densities: a hypothetical alloy having a density of 1 g/cm³, aluminum with density of 2.7 g/cm³ and gold having density of 19.32 g/cm³.

For laterally oriented wedges, the acceleration (in the x direction) results from a lateral (in the x direction) component of force 21005 on mass M₁₁₀₀₅ or force 24005 on mass M₁₄₀₀₅. For normally oriented wedges the acceleration (in the z direction) results from normal force 25005 on mass M₁₅₀₀₅. All plots are in terms of the thickness of the unit volumes Z₁₁₀₀₅, Z₁₄₀₀₅ and Z₁₅₀₀₅.

The effectiveness of flying vehicle propulsion systems depends upon its thrust to weight ratio, which is the ratio of the thrust the engine produces to engine weight. Its importance can be illustrated by the role it played in the development of the first aircraft. At the time of the Wright brothers Flyer, steam engines existed that had the power to propel the aircraft. However they were much too heavy. It was the appearance of the internal combustion engine with its lighter weight and thus higher thrust to weight ratio that allowed the Wright Flyer to work.

The analogous concept for a force cell is the force per unit mass, which is its intrinsic acceleration. When that acceleration is expressed in terms of Earth gravities it is in fact the thrust to weight ratio.

Calculating Intrinsic Acceleration/Thrust to Weight Ratio

The following sample calculations provide examples of possible capabilities of force cells. They are not optimized and in some cases involve some simplifications to what is disclosed in the specification in order to provide increased clarity. A sample calculation will be provided for each of the single sided laterally oriented wedge embodiments (FIG. 4 to FIG. 8), the double-sided laterally oriented wedge embodiments (FIG. 36 to FIG. 40) and the normally oriented wedge embodiments (FIG. 41 to FIG. 44). All wedges considered are simple, straight edge wedges that are amenable to Perfectly Conducting Wedge theory.

Intrinsic acceleration is obtained by dividing the external force output of a unit volume (21005 for single sided laterally oriented wedge embodiments, 24005 for double sided laterally oriented wedge embodiments and 25005 for normally oriented wedge embodiments) by the mass of the unit volume. The thrust to weight ratio is obtained by dividing the intrinsic acceleration by Earth normal gravitational acceleration (g_{E}=9.8 m/sec² or 980 cm/sec²).

According to the perfectly conducting wedge theory the magnitude of total force perpendicular to a wedge surface for the wedge shown in FIG. 1 is:

$${F}_{⊥ 1} = {F}_{⊥ 2} = {\int }_{0}^{Y} dy {\int }_{{R}_{0}}^{{R}_{1}} f ( r ) dr = \vert \frac{ℏ cY ( {p}^{2} - 1 ) ( {p}^{2} + 11 )}{720 {π}^{2} \sqrt{{ɛ}_{r} {μ}_{r}}} ( \frac{1}{{R}_{1}^{3}} - \frac{1}{{R}_{0}^{3}} ) \vert \\ where p = \frac{π}{α} . \qquad ( 8 )$$

Equation 8 is derived from Equation 6 where the relative dielectric constant εᵣ and relative magnetic permeability μᵣ are the dielectric and permeability of the cavity material—the material between the wedge faces.

The direction of the wedge surface perpendicular force goes from the material with the higher relative dielectric constant or optical density to that of the lower. In the ensuing calculations all materials, both conductors and non-conductors are non-magnetic meaning that one can assume the relative magnetic permeability of materials to be μᵣ₀=μ₀=1. For simplicity, the relative dielectric constants will be assumed to be 1 for non-conductors and infinite for conductors. With εᵣ=ε₀=1 and μᵣ=μ₀=1 Equation 8 becomes Equation 2.

Thrust to Weight Ratio for Single Sided Laterally Oriented Wedge Embodiments

From the geometry of the wedges depicted in FIG. 8A and FIG. 8B one can calculate thrust to weight ratio for a unit volume of single sided, laterally oriented wedge profile force cell in terms of the unit volume thickness (Z₁₁₀₀₅). For simplicity F_{21005Lateral} is calculated instead of 21005 and is actually less than 21005. Varying the length z₂ depicted in the drawings modifies the unit volume thickness. The following are held constant having more or less arbitrary values: wedge angles α=0.2 π, μ=π/2, length A=350 nm, plasma wavelength λₚ=130 nm.

$${R}_{0} = \frac{{λ}_{p}}{2 sin ( \frac{π - α}{2} )} , {R}_{1} = \frac{{λ}_{p}}{2 sin ( \frac{α}{2} )} , {R}_{2} = \frac{A}{sin α} , {R}_{3} ( {z}_{2} ) = \frac{{z}_{2}}{sin α} , \\ {R}_{4} ( {z}_{2} ) = \frac{{z}_{2} + A}{sin α}$$

Calculating the magnitude of forces perpendicular to the faces of wedge QOT:

$${F}_{⊥ QOT} = \vert \frac{ℏ {cY}_{Layer} ( {p}^{2} - 1 ) ( {p}^{2} + 11 )}{720 {π}^{2} \sqrt{{ɛ}_{0} {μ}_{0}} } ( \frac{1}{{R}_{2}^{3}} - \frac{1}{{R}_{1}^{3}} ) \vert$$

Calculating the magnitude of forces perpendicular to the faces of wedge POT:

$${F}_{⊥ POT} = \vert \frac{ℏ {cY}_{Layer} ( {q}^{2} - 1 ) ( {q}^{2} + 11 )}{720 {π}^{2} \sqrt{{ɛ}_{0} {μ}_{0}}} ( \frac{1}{{R}_{2}^{3}} - \frac{1}{{R}_{0}^{3}} ) \vert$$

Calculating the magnitude of forces perpendicular the faces of wedge OTS:

$${F}_{⊥ OTS} ( {z}_{2} ) = \vert \frac{ℏ {cY}_{Layer} ( {p}^{2} - 1 ) ( {p}^{2} + 11 )}{720 {π}^{2} \sqrt{{ɛ}_{0} {μ}_{0}}} ( \frac{1}{{R}_{4}^{3}} - \frac{1}{{R}_{3}^{3}} ) \vert$$

Calculating the magnitude of forces perpendicular to the faces of wedge OTU:

$${F}_{⊥ OTU} ( {z}_{2} ) = \vert \frac{ℏ {cY}_{Layer} ( {q}^{2} - 1 ) ( {q}^{2} + 11 )}{720 {π}^{2} \sqrt{{ɛ}_{0} {μ}_{0}} } ( \frac{1}{{R}_{4}^{3}} - \frac{1}{{R}_{3}^{3}} ) \vert$$

$$where p = \frac{π}{α} and q = \frac{π}{π - α}$$

Calculating the external lateral force for the system of wedges:

$${F}_{21005 Lateral} ( {z}_{2} ) = sin α ( \text{?} - \text{?} - \text{?} ( {z}_{2} ) + \text{?} ( {z}_{2} ) )$$

$$\text{?} \text{indicates text missing or illegible when filed}$$

The mass of the unit volume 11005 is calculated as:

$${M}_{11005} ( {z}_{2} , {ρ}_{cond} ) = {Y}_{Layer} \cdot {L}_{11005} \cdot d \cdot {ρ}_{cond} + {Y}_{Layer} ( {L}_{11005} \cdot {Z}_{11005} ( {z}_{2} ) - \frac{{L}_{11005} \cdot {h}_{t}}{2} ) {ρ}_{matrix} + {Y}_{Layer} \cdot d \cdot {R}_{2} cos α \cdot {ρ}_{cond}$$

In this calculation the following values were used: force cell width Y_{Layer}=1 cm, force cell groove and unit volume width L₁₁₀₀₅=1 μm, conductor thickness d=30 nm. The density of a conductor ρ_{cond} is assumed to be 2.7 g/cm³ for aluminum. The unit volume thickness Z₁₁₀₀₅ is defined as:

$${Z}_{11005} ( {z}_{2} ) = {z}_{2} + 2 d + A$$

Groove depth hₜ is defined as:

$${h}_{t} = {L}_{11005} sin α \cdot cos α$$

The density of the non-conducting matrix material used is: ρₘₐₜᵣᵢₓ=1 g/cm³. The thrust to weight version of intrinsic acceleration becomes:

$${a}_{11005} ( {z}_{2} , {ρ}_{cond} ) = \frac{{F}_{21005 \text{?}} ( {z}_{2} )}{{M}_{11005} ( {z}_{2} , {ρ}_{cond} ) \cdot {g}_{E}}$$

$$\text{?} \text{indicates text missing or illegible when filed}$$

(Notice that the force cell width Y_{Layer} cancels out of the calculation.)

The intrinsic acceleration is shown in the plot of FIG. 35A for the conductor density being that of aluminum.

Thrust to Weight Ratio for Double Sided Laterally Oriented Wedge Embodiments

From the geometry of the wedges depicted in FIG. 40A and FIG. 40B one can calculate thrust to weight ratio for a unit volume of double sided, laterally oriented wedge profile force cell in terms of the unit volume thickness (Z₁₄₀₀₅). For simplicity, FIG. 40B shows the grooves on each side of non-conducting matrix material 14001 aligned on top of each other with the γ angle equal to zero. Making the γ angle zero increases the lateral force somewhat but aligning the grooves over each other as shown in FIG. 40B reduces the lateral force somewhat, reducing the effect of the simplification. Varying the length z₂ depicted in the drawings modifies the unit volume thickness. The following are held constant with the more or less arbitrary values: wedge angles α=0.2 π, β=π/2, length A=350 nm, plasma wavelength λₚ=130 nm.

$${R}_{0} = \frac{{λ}_{p}}{2 sin ( \frac{π - α}{2} )} , {R}_{1} = \frac{{λ}_{p}}{2 sin ( \frac{α}{2} )} , {R}_{2} = \frac{A}{sin α} , {R}_{3} ( {z}_{2} ) = \frac{{z}_{2}}{sin α} , \\ {R}_{4} ( {z}_{2} ) = \frac{{z}_{2} + 2 A}{sin α}$$

Calculating the magnitude of forces perpendicular to the faces of wedge QOR:

$${F}_{⊥ QOR} = \vert \frac{ℏ {cY}_{Layer} ( {p}^{2} - 1 ) ( {p}^{2} + 11 )}{720 {π}^{2} \sqrt{{ɛ}_{0} {μ}_{0}}} ( \frac{1}{{R}_{2}^{3}} - \frac{1}{{R}_{1}^{3}} ) \vert$$

$$p = \frac{π}{α}$$

Calculating the magnitude of forces perpendicular to the faces of wedge POR:

$${F}_{⊥ POR} = \vert \frac{ℏ {cY}_{Layer} ( {p}_{1}^{2} - 1 ) ( {p}_{1}^{2} + 11 )}{720 {π}^{2} \sqrt{{ɛ}_{0} {μ}_{0}}} ( \frac{1}{{R}_{2}^{3}} - \frac{1}{{R}_{0 }^{3}} ) \vert$$

$${p}_{1} = \frac{π}{π - α}$$

Calculating the magnitude of forces perpendicular to the faces of wedge ORT:

$${F}_{⊥ ORT} ( {z}_{2} ) = \vert \frac{ℏ {cY}_{Layer} ( {p}_{2}^{2} - 1 ) ( {p}_{2}^{2} + 11 )}{720 {π}^{2} \sqrt{{ɛ}_{0} {μ}_{0}}} ( \frac{1}{{R}_{4}^{3}} - \frac{1}{{R}_{3 }^{3}} ) \vert$$

$${p}_{2} = \frac{π}{2 α}$$

Calculating the external lateral force for the system of wedges:

$${F}_{24005} ( {z}_{2} ) = sin α \cdot ( 2 \text{?} - 2 \text{?} - 2 \text{?} ( {z}_{2} ) )$$

$$\text{?} \text{indicates text missing or illegible when filed}$$

The mass of the unit volume 14005 is calculated as:

$${M}_{14005} ( {z}_{2} , {ρ}_{cond} ) = 2 {Y}_{Layer} {d}_{14005} {d}_{1} {ρ}_{cond} + {Y}_{Layer} ( {L}_{14005} ( {z}_{2} + 2 A ) - \frac{{L}_{14005} {h}_{t}}{2} ) {ρ}_{matrix} + 2 {Y}_{Layer} {ρ}_{cond} {R}_{2} d cos α$$

Additional parameters are: L₁₄₀₀₅=1 μm, d₁=150 nm, z₄=0, Y_{Layer} =1 cm The density of conductor ρ_{cond} is 2.7 g/cm³ for aluminum. The unit volume thickness Z₁₄₀₀₅, is defined as:

$${z}_{14005} ( {z}_{2} ) = {z}_{2} + 2 d + 2 {d}_{1} + 2 A + {z}_{4}$$

Groove depth hₜ is defined as:

$${h}_{t} = {L}_{14005} sin α \cdot cos α$$

The thrust to weight version of intrinsic acceleration is thus:

$${a}_{14005} ( {z}_{2} , {ρ}_{cond} ) = \frac{{F}_{24005} ( {z}_{2} )}{{M}_{14005} ( {z}_{2} , {ρ}_{cond} ) \cdot {g}_{E}}$$

(Notice that the force cell width Y_{Layer} cancels out of the calculation.)

The intrinsic acceleration is shown in the plot of FIG. 35A for the conductor density being that of aluminum.

Thrust to Weight Ratio for Normally Oriented Wedge Embodiments

From the geometry of the wedges depicted in FIG. 44 one can calculate thrust to weight ratio for a unit volume of normally oriented wedge profile force cell in terms of the unit volume thickness (Z₁₅₀₀₅). Varying the lengths z₁ and z₂ depicted in the drawings modifies the unit volume thickness. For simplicity z₁ is made to be equal to z₂. The following are held constant with the more or less arbitrary values: wedge angles α=π/4, β=π/2, plasma wavelength λₚ=130 nm, L₁₅₀₀₅=1 μm.

$${R}_{0} = \frac{{λ}_{p}}{2 sin ( \frac{β}{2} )} , {R}_{1} = \frac{{L}_{15001}}{2 sin ( \frac{β}{2} )} , \\ {R}_{3} ( {z}_{2} ) = \frac{{z}_{2}}{cos ( \frac{β}{2} )} , {R}_{4} ( {z}_{2} ) = {R}_{1} + {R}_{3} ( {z}_{2} )$$

Calculating the magnitude of forces perpendicular to the faces of wedge ABC:

$${F}_{⊥ ABC} = \vert \frac{ℏ {cY}_{Layer} ( {p}^{2} - 1 ) ( {p}^{2} + 11 )}{720 {π}^{2} \sqrt{{ɛ}_{0} {μ}_{0}}} ( \frac{1}{{R}_{1}^{3}} - \frac{1}{{R}_{0}^{3}} ) \vert$$

$$p = \frac{π}{β}$$

Calculating the magnitude of forces perpendicular to the faces of wedge B′EB:

$${F}_{⊥ BpEB} = \vert \frac{ℏ {cY}_{Layer} ( {q}^{2} - 1 ) ( {q}^{2} + 11 )}{720 {π}^{2} \sqrt{{ɛ}_{0} {μ}_{0}}} ( \frac{1}{{R}_{4}^{3}} - \frac{1}{{R}_{3 }^{3}} ) \vert$$

$$q = \frac{π}{α}$$

Calculating the magnitude of forces perpendicular to the faces of wedge FAB:

$${F}_{⊥ FAB} = \vert \frac{ℏ {cY}_{Layer} ( {p}^{2} - 1 ) ( {p}^{2} + 11 )}{720 {π}^{2} \sqrt{{ɛ}_{cond} {μ}_{0}}} ( \frac{1}{{R}_{1}^{3}} - \frac{1}{{R}_{0}^{3}} ) \vert = 0$$

$${ɛ}_{cond} -> ∞$$

$$p = \frac{π}{β}$$

Calculating the magnitude of forces perpendicular to the faces of wedge GHJ:

$${F}_{⊥ GHJ} = \vert \frac{ℏ {cY}_{Layer} ( {p}^{2} - 1 ) ( {p}^{2} + 11 )}{720 {π}^{2} \sqrt{{ɛ}_{0} {μ}_{0}}} ( \frac{1}{{R}_{1}^{3}} - \frac{1}{{R}_{0}^{3}} ) \vert = 0$$

$$p = \frac{π}{β = π} = 1$$

Calculating the external normal force for the system of wedges:

$${F}_{25005} ( {z}_{2} ) = 2 cos ( \frac{β}{2} ) \cdot {F}_{⊥ ABC} - 2 {F}_{⊥ BpEB} ( {z}_{2} ) + 2 sin ( \frac{β}{2} ) \cdot {F}_{⊥ BpEB} ( {z}_{2} )$$

The mass of the unit volume 15005 is calculated as:

$${M}_{15005} ( {z}_{1} , {z}_{2} , {ρ}_{cond} ) = {L}_{15005} \cdot {Y}_{Layer} ( {z}_{2} \cdot {ρ}_{matrix} + {z}_{1} \cdot {ρ}_{cond} + \frac{{h}_{t}}{2} \cdot {ρ}_{cond} )$$

The density of the conductor ρ_{cond} is a variable being: 1 g/cm³ for some hypothetical alloy, 2.7 g/cm³ for aluminum and 19.32 g/cm³ for gold.

The unit volume thickness Z₁₅₀₀₅ is defined as:

$${Z}_{15005} ( {z}_{1} , {z}_{2} ) = {z}_{1} + {z}_{2} + {h}_{t}$$

Groov depth hₜ is defined as:

$${h}_{t} = \frac{{L}_{15005}}{2 tan ( \frac{β}{2} )}$$

The intrinsic acceleration in terms of Earth gravities is thus:

$${a}_{15005} ( {z}_{1} , {z}_{2} , {ρ}_{cond} ) = \frac{{F}_{24005} ( {z}_{2} )}{{M}_{15005} ( {z}_{1} , {z}_{2} , {ρ}_{cond} ) \cdot {g}_{E}}$$

(Notice that the force cell width Y_{Layer} cancels out of the calculation.)

The intrinsic acceleration is shown in the plot of FIG. 35A for the conductor density being that of aluminum and in FIG. 35B for the conductor densities being that of a hypothetical alloy, aluminum and gold.

The thrust to weight ratio or intrinsic acceleration was calculated for a single unit volume. But because both mass and force scale the same way, the intrinsic acceleration for N unit volumes is the same as lot one. Inversely, the number of unit volumes in a force cell is the total volume of the force cell divided by the unit volume or the total mass divided by the mass of a unit volume. Not only is the intrinsic acceleration of a force cell independent of the volume and mass but also it is independent of all dimensions making up the volume. Note that some allowance must be given for the sheathing.

Some Observations from the Plots of FIG. 35A and FIG. 35B

For all the plots of both FIG. 35A and FIG. 35B, as the layer or unit volume thickness becomes smaller the intrinsic acceleration reaches a maximum then falls precipitously. FIG. 35A shows that for a particular conductor density, the single sided laterally oriented wedge embodiment performs the best for small layer thickness. But as layer thickness increases the double sided laterally oriented wedge embodiment performs almost twice as good as either the single sided laterally oriented wedge embodiment or the normally oriented wedge embodiment. FIG. 35B shows that the normally oriented wedge embodiment shows particular sensitivity to conductor density. It would not be expected that the laterally oriented embodiments would show such sensitivity since conductors make up proportionately smaller parts of their mass. However the mass sensitivity of the normally oriented wedge embodiment works both ways. For a really light conductor such as an alloy containing lithium, the normally oriented wedge embodiment significantly outperforms the singe sided laterally oriented wedge embodiment for smaller layer thickness and can perform at least as well as the doubly sided laterally oriented wedge embodiments for large layer thicknesses.

Of course all embodiments will see improvements by reducing the density and even the relative dielectric constant of the non-conducting matrix material. Besides using less dense materials and making layers as thin as possible it might be possible to optionally inject non-conductors with nano-bubbles. Styrofoam is a familiar form of plastic made by inserting air bubbles into styrene plastic. The bubbles in Styrofoam are much too large to be useful in the non-conductors. The bubbles should be in the nano-meter range. Such small bubbles have been successfully inserted into water and are stable at the nano-scale. The insertion of nano-bubbles into a plastic polymer is seeing advances that may further aid production of embodiments disclosed herein. See e.g., P. A. O'Connell and G. B. McKenna, A Novel Nano-bubble Inflation Method for Determining the Viscoelastic Properties of Ultrathin Polymer Films. The Journal of Scanning Microscopics, Vol. 30. 184-196 (2008). Wiley Periodicals. Inc.; and Dollekamp E, et al., Electrochemically Induced Nanobubbles between Graphene and Mica, Langmuir. 2016 Jul. 5; 32(26):6582-90, doi: 10.1021/acs.langmuir.6b00777.

### PREFERRED EMBODIMENTS OF THE INVENTION

Force cells can be embodied to provide vehicle propulsion, where FIGS. 18-22 and 30 show multiple flat layer propulsion embodiments and FIGS. 23-29 and 31 show the spiral and/or cylindrical propulsion embodiments. Flat and Spiral/Cylindrical force cells can also be embodied to provide power where FIGS. 33A-33C show the power embodiment. Standard sized force cells allow for mass production for use in either propulsion or power embodiments.

The propulsion mass Mₚᵣₒₚ of a vehicle will be N*M_{FC} where N is the number of force cells comprising a vehicle's propulsion system and M_{FC} is the mass of a force cell. If all force vectors are pointing in the same direction, the following simplified relation holds:

$$\text{?} \cdot {M}_{prop} = \text{?} \cdot N \cdot {M}_{FC} = N \cdot {F}_{FC} = \text{?} = {a}_{vehicle} \cdot {M}_{Total \_ vehicle}$$

$$\text{?} \text{indicates text missing or illegible when filed}$$

Given an intrinsic acceleration the vehicle acceleration will be for a particular mass fraction:

$${a}_{vehicle} = \frac{{M}_{prop}}{{M}_{Total \_ vehicle}} \cdot {a}_{int}$$

Where M_{Total_vehicle}=M_{vehicle_structure}+MₚᵣₒₚM_{Cargn}.

Thus for a particular intrinsic acceleration, which is technology dependent, the same propulsion to total vehicle mass fraction will give the same maximum vehicle acceleration, no matter the size of the vehicle, providing all the force cell acceleration vectors are pointing in the same direction.

FIGS. 35A and 35B show that the force cell has considerable potential for technological improvement. Early embodiments of the force probably have thicker Z₁₁₀₀₅, Z₁₄₀₀₅, or Z₁₅₀₀₅ thus smaller thrust to weight ratio.

Force cells with thrust to weight ratio less than 1 g_{E} could be useful for in-space propulsion even enabling round trips to the Moon and Mars. Landings on the Moon and Mars might be possible with sufficiently high propulsion to vehicle mass fraction (but still less than 1 g_{E}). Unfortunately such vehicles would require boosting into orbit from Earth using at conventional rocket thus increasing their cost of use and reducing their value as a startup application.

The usefulness of force cells with thrust to weight ratio greater than 1 g_{E} depends upon how much greater and what kind of mass fractions it enables. With a thrust to weight ratio as little as 1.22 g_{E}, a vehicle with rocket like mass fractions could directly travel into space. Once there it would be able land and take-off on the Moon and Mars. However, its cargo carrying capability would be small.

Force cells with thrust to weight ratio of a bit more than double the 1.22 gE or about 2.5 gE could provide propulsion to a vehicle with aircraft like mass fractions with aircraft like cargo carrying capability and yet be capable of traveling into space and between planets and moons. It would also be capable of taking off and landing vertically and then traveling at hypersonic speeds above the atmosphere for point-to-point service anywhere on Earth without special thermal protection requirements. In space with constant vehicle acceleration and deceleration of 1 g_{E}, a trip to the Moon could be accomplished in a little over three hours while a trip to Mars could be made in two to four days. Amazingly a robotic probe could reach Alpha Centauri in about five years and with subsequent transmission of data of four years, result in a mission time of nine years, or the mission time of NASA's New Horizons Mission.

Still higher thrust to weight ratios could enable silent flying cars with surface car cargo carrying capabilities. Basically, higher thrust-to-weight ratios mean more applications can exist. However a first application needs to start small. Luckily, the physics of the force cell is amenable to starting small, as opposed to technologies such as fusion or space solar power where the physics requires large initial investment, or even rockets, which are bound by the exponential nature of the rocket equation. Initial force cell applications should provide high value-added and require only small numbers of manufactured items.

### Starting Small

A startup class for cell with thrust to weight ratio greater than 1 but less than 2 gE could enable a small high altitude long endurance scientific, surveillance or communication drone. There is currently no competition for vehicles that can go higher than a balloon and stay up longer than a sounding rocket. Revenue from smaller applications can facilitate progression to larger applications.

Power generation can follow the same strategy as that of propulsion with smaller high value low manufacturing volume markets coming first with gradual immersion into mass markets. Thus a natural first market would be the powering of space vehicles. Force cell based power generation could be more compact than comparatively powered solar cell technology, but would be increasingly advantageous in space missions farther from the sun. With maturity, force cell power generation could be a part of the power system in electric cars, trains, sea vessels, homes, offices and factories as well as directly powering appliances.

### Power Output of a Torque Generator

The power output of a torque generator P is the time rate of change of the kinetic energy T of the rotating system or:

$$P = \frac{dT}{dt} = \frac{d}{dt} ( \frac{1}{2} {I}_{z} {ω}^{2} ) = {I}_{z} ω \text{?} = ( {I}_{z} \text{?} ) ω = {τ}_{z} ω = \sum ( {F}_{FC} \times R ) ω = \sum ( {M}_{FC} \cdot {a}_{int} \times R ) ω$$

$$\text{?} \text{indicates text missing or illegible when filed}$$

where I_{z} is the moment of inertia, ω is the rotational velocity, [symbol] is the output torque, M_{FC} is the mass of a force cell, F_{FC} is the force cell rotational force, αᵢₙₜ is the intrinsic acceleration of the force cell and R is the torque lever.
However the centrifugal force is:

$${F}_{Centrifugal} = {M}_{FC} R {ω}^{2}$$

The power output is directly proportional to the force cell rotational force, the torque lever and the anaular or rotational velocity. Intrinsic acceleration is the rotational force cell force divided by the force cell mass, therefore force cell mass is not a factor in power output. On the other hand, the centrifugal force is proportional to the force cell mass, the torque lever and the square of the rotational velocity. The only parameter in the power output that is not in the centrifugal force is the force cell rotational force. So the best way to increase power output is to increase force cell rotational force and the worst way is to increase rotational velocity.

While illustrative implementations of one or more embodiments of the present invention are provided hereinabove, those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the exemplary embodiments without departing from the spirit of this invention.

Accordingly, the breadth and scope of the present disclosure should not be limited by any of the above-described example embodiments, but should be defined only in, accordance with the following claims and their equivalents.

1. A force cell comprising:
a) a first non-conducting matrix layer having a thickness defined by a top surface and a bottom surface;
b) wherein said first matrix layer has a first plurality of grooves beginning at said top surface and extending a distance into said first matrix layer to a depth, and said first plurality of grooves extending across at least a portion of said top surface; and wherein said first matrix layer has a second plurality of grooves beginning at said bottom surface and extending said distance into said first matrix layer to a depth, said second plurality of grooves extending across at least a portion of said bottom surface;
c) wherein each of said first plurality of grooves comprise a descending surface extending from an apex proximate to said top surface of said first matrix layer, terminating at a low point and an ascending surface extending from where said descending surface terminates, to next apex in said top surface of said first matrix layer; and wherein each of said second plurality of grooves comprise a descending surface extending from an apex proximate to said bottom surface of said first matrix layer, terminating at a low point and an ascending surface extending from where said descending surface terminates, to next apex in said bottom surface of said first matrix layer;
d) a conductive coating over at least a portion of each said descending surface of each said groove in said top and bottom surfaces of said first matrix layer beginning at an apex;
e) a first conducting sheet having a top surface and bottom surface;
f) wherein coated descending surface of each said groove of said bottom surface of said first matrix layer is in contact with top surface of said first conducting sheet;
g) a second non-conducting matrix layer having a thickness defined by a top surface and a bottom surface;
h) wherein said second matrix layer has a first plurality of grooves beginning at said top surface and extending a distance into said second matrix layer to a depth, and said first plurality of grooves extending across at least a portion of said top surface; and wherein said second matrix layer has a second plurality of grooves beginning at said bottom surface and extending said distance into said second matrix layer to a depth, said second plurality of grooves extending across at least a portion of said bottom surface;
i) wherein each of said first plurality of grooves comprise a descending surface extending from an apex proximate to said top surface of said second matrix layer, terminating at a low point and an ascending surface extending from where said descending surface terminates, to next apex in said top surface of said second matrix layer; and wherein each of said second plurality of grooves comprise a descending surface extending from an apex proximate to said bottom surface of said second matrix layer, terminating at a low point and an ascending surface extending from where said descending surface terminates, to next apex in said bottom surface of said second matrix layer;
j) a conductive coating over at least a portion of each said descending surface of each said groove in said top and bottom surfaces of said second matrix layer beginning at an apex;
k) wherein coatings of grooves of top surface of second matrix layer are in contact with bottom surface of first conducting sheet;
l) a second conducting sheet having a top surface and bottom surface;
m) wherein coated descending surface of each said groove of said bottom surface of said second matrix layer is in contact with top surface of said second conducting sheet;
n) wherein said coated descending surface for each groove of said top surface of a matrix layer and bottom surface of a conducting sheet create wedges;
o) wherein said coated descending surface for each groove of said bottom surface of a matrix layer and top surface of a conducting sheet create wedges;
p) wherein each said coated descending surface of each said groove in said top surface of a matrix layer create a first Casimir force perpendicular to said descending surface of each said groove, and wherein each bottom surface of said conducting sheet create a second Casimir force perpendicular to said bottom surface of said conducting sheet;
q) wherein each said coated descending surface of each said groove in said bottom surface of a matrix layer create a third Casimir force perpendicular to said descending surface of said grooves of said bottom surface, and wherein each top surface of said conducting sheet create a fourth Casimir force perpendicular to said top surface of said conducting sheet;
r) wherein said first, second, third and fourth Casimir forces combine to provide a net force in a direction.

2. The force cell according to claim 1 wherein a plurality of said grooved and coated first matrix layers, said first conducting sheets, said grooved and coated second matrix layers, and said second conducting sheets are stacked to form a force cell bundle.

3. The force cell according to claim 2 wherein a plurality of said force cell bundles are stacked to form a force cell.

4. The force cell according to claim 1 wherein said grooved and coated first matrix layer, said first conducting sheet are rolled into a spiral.

5. The force cell of claim 1, wherein each of said grooves of said top surface of said first and second matrix layers are substantially parallel; wherein each of said grooves of said bottom surface of said first and second matrix layers are substantially parallel and wherein said grooves of said top and bottom surfaces of said first and second matrix layers are oriented at an angle gamma that may be between 0° and 90° of each other; wherein a said angle gamma of 0° produces the maximum lateral force but minimum structural rigidity, while a said angle gamma of 90° produces about 71% of maximum lateral force and maximum structural rigidity, while a said angle greater than 90° produces both less lateral force and less structural rigidity.

6. The force cell of claim 1, wherein each said matrix layer is formed of a non-conducting material having low density, preferably having a specific gravity of 1 or less, being non-magnetic, having a relative dielectric constant as close to 1 as possible.

7. The force cell of claim 6, wherein for propulsion embodiments each said matrix layer may be formed of one or more of but not be limited to: polyethylene with a dielectric of 1.2 to 2.3, and a density of about 0.88 to 0.96 g/cc, polystyrene with a dielectric of 2.4 to 2.7 and a density of 0.96 to 1.06 g/cc, and polypropylene with a dielectric of 1.6 to 2.4 and a density of 0.85 to 0.95 g/cc, polyvinyl chloride with dielectric 2.4 to 2.7 and density 1.1 to 1.45 g/cc; wherein for non-propulsion embodiments such as rotary embodiments for power generation each said matrix layer may additionally be formed of one or more of but not be limited to: polytetraflouroethylene (PTFE, Teflon®) with dielectric 2.0 and density 2.2 g/cc.

8. The force cell according to claim 7, wherein said dielectric constant and density of said matrix layer material can be lowered through injection of nano-bubbles.

9. The force cell of claim 1, wherein each of said conducting layers and said conducting coatings is a good conductor with conductivity comparable to that of a metal, with low density, preferably having a specific gravity as close to 1 as possible and a small plasma-wavelength (λₚ}, where said plasma wavelength is the shortest wavelength that a photon interacts with a conductor, shorter wavelength photons tending to pass through with 80 to 100 nm being considered low.

10. The force cell of claim 9 wherein for propulsion embodiments, each of said conducting layers, said conducting coatings and said conducting sheets may be comprised of one of the following conductors or alloys thereof to produce a said good conductor with low density and associated plasma wavelength, examples of which include but are not limited to: lithium (sp. gr. 0.534 at 20° C.; λₚ: 150 to 205 nm), beryllium (sp. gr. 1.848 at 20° C.; λₚ: NA), magnesium (sp. gr. 1.738 at 20° C.: λₚ: NA), and aluminum (sp. gr. 2.6989 at 20° C.; λₚ: 80 to 100 nm); wherein for non-propulsion embodiments such as rotary embodiments for power generation, each of said conducting layers, said conducting coatings and said conducting sheets may be comprised of one of the additional conductors or alloys thereof to produce a said good conductor and associated density and plasma wavelength, examples of which include but are not limited to: titanium (sp. gr. 4.54, λₚ: N/A), cobalt (sp. gr. 8.9, λₚ: N/A), nickel (sp. gr. 8.9, λₚ: 110 to 150 nm), copper (sp. gr, 8.96, λₚ: 140 to 170 nm), molybdenum (sp. gr. 10.22, λₚ: N/A), silver (sp. gr. 10.5, λₚ: 105 to 170 nm), lead (sp. gr. 11.35, λₚ: N/A), tantalum (sp. gr. 16.6, λₚ: N/A), tungsten (sp. gr. 19.3 λₚ: N/A), gold (sp. gr. 19.32, λₚ: 135 to 180 nm) and/or platinum (sp. gr. 21.45, λₚ: 210 to 280 nm).

11. The force cell according to claim 1, wherein each of said plurality of grooves typically have an apex-to-apex spacing greater than said plasma wavelength for conductor.

12. The force cell of claim 9 wherein said conducting coating have a thickness in the range of greater than 10 nano-meters to about 100 nano-meters.

13. The force cell of claim 9 wherein each said conducting sheet has a thickness of less than one quarter to more than one third the apex-to-apex spacing depending upon said angle gamma, where the closer the said angle gamma is to 0° the greater the thickness of the conducting sheet and where the closer the said angle gamma is to 90° the thinner the thickness of the conducting sheet can be.

14. The force cell of claim 1, wherein said thickness of each of said matrix layer is greater than or equal to the thickness at which force cell achieves maximal intrinsic acceleration, typically greater than three quarters to one and one quarter microns and typically less than 50 microns.

15. The force cell according to claim 1 wherein said depth of each of said plurality of grooves in said matrix layers is less than one half the thickness of said matrix layers.

16. The force cell according to claim 3 wherein said force cell is enclosed with a sheath material, examples of which comprise but are not limited to: latex with a density of 0.92 to 0.96 g/cc, neoprene with a density of 1.2 to 1.24 g/cc, nylon with a density of 1.1 g/cc or said matrix material; and wherein said enclosed force cell empty spaces are preferably vacuum or filled with a non-reacting gas examples of which include but are not limited to: nitrogen, helium and argon.

17. The force cell according to claim 4 wherein said first matrix layer together with said conducting coatings on said grooves and said first conducting sheet and is rolled into a plurality of windings to form a spiral around a spindle that has an axis; wherein said spindle axis is also the axis of staid spiral; wherein said spiral, each part of said winding is at a radius from the axis; wherein each said groove in each said winding is aligned perpendicularly to said axis and approximately perpendicular to said radius at said part of said winding;

18. The force cell according to claim 4 wherein each said apex of coated groove in said top surface of said first matrix layer its in contact with said bottom surface of current winding of conducting sheet of said spiral and each said apex of coated groove in said bottom surface of said first matrix layer is in contact with top surface of previous winding of conducting sheet of said spiral;

19. The force cell according to claim 4 wherein said force cell is enclosed with a sheath material, examples of which comprise but are not limited to: latex with a density of 0.92 to 0.96 g/cc, neoprene with a density of 1.2 to 1.24 g/cc, nylon with a density of 1.1 g/cc or said matrix material; and wherein said enclosed force cell empty spaces are preferably vacuum or filled with a non-reacting gas examples of which include but are not limited to: nitrogen, helium and argon.

20. The force cell according to claim 1 wherein an optional surface of zero slope, being parallel to said top surface of said first and second matrix layers, extends from where said descending surface of said first plurality of grooves terminates at a low point to said ascending surface; an optional surface of zero slope along the said top surface of said first and second matrix layers extending from where said ascending surface of said first plurality of grooves terminates at next apex to next descending surface; an optional surface of zero slope, being parallel to said bottom surface of said first and second matrix layers, extends from where said descending surface of said second plurality of grooves terminates at a low point to said ascending surface, an optional surface of zero slope along the said bottom surface of said first and second matrix layers extending from where said ascending surface of said second plurality of grooves terminates at next apex to next descending surface.

21-41. (canceled)
